(19) United States
(12) Patent Application Publication
(10) Pub. No.: US 2026/0232413 A1
(43) Pub. Date: Aug. 13, 2026

(54) OVERCOMING EXTERNAL ILLUMINATION IN INTRAORAL SCANNING

(71) Applicant: Align Technology, Inc., San Jose, CA (US)

(72) Inventors: Ofer Saphier, Rechovot (IL); Rahul Prabhu, Bengaluru (IN)

(21) Appl. No.: 19/433,462

(22) Filed: Dec. 26, 2025

Related U.S. Application Data
(60) Provisional application No. 63/755,963, filed on Feb. 7, 2025.

(51) Int. Cl. A61C 9/00

(52) U.S. Cl. CPC A61C 9/006

(57) ABSTRACT

An intraoral scanner includes one or more structured light projectors configured to project structured light comprising a light pattern, one or more non-structured light projectors configured to project non-structured light, and one or more cameras configured to capture intraoral scan data comprising one or more images of a dental object illuminated by at least one of the one or more structured light projectors or the one or more non-structured light projectors. The intraoral scanner or a computing device connected to the intraoral scanner is configured to estimate an amount of external illumination based on a) a known first intensity at which the one or more structured or non-structured light projectors projected light and b) a captured intensity in the one or images of the dental object for one or more color channels, and is further configured to perform an action based on the estimated amount of external illumination.

### RELATED APPLICATIONS

This patent application claims the benefit under 35 U.S.C. § 119 (e) of U.S. Provisional Application No. 63/755,963, filed Feb. 7, 2025, which is incorporated by reference herein.

### TECHNICAL FIELD

Embodiments of the present disclosure relate to the field of intraoral scanning and, in particular, to a system and method for overcoming external illumination for intraoral scanning.

### BACKGROUND

In prosthodontic procedures designed to implant a dental prosthesis in the oral cavity, the dental site at which the prosthesis is to be implanted in many cases should be measured accurately and studied carefully, so that a prosthesis such as a crown, denture or bridge, for example, can be properly designed and dimensioned to fit in place. A good fit enables mechanical stresses to be properly transmitted between the prosthesis and the jaw, and to prevent infection of the gums via the interface between the prosthesis and the dental site, for example. Some procedures also call for prosthetics to be fabricated to replace one or more missing teeth, such as a partial or full denture. For prosthodontic procedures, it can be important to generate dental prosthetics having a color that accurately reflects a color of the patient's teeth. If the color of the dental prosthetic fails to match the color of the patients' existing teeth, then such a color mismatch can be easily seen when the patient smiles.

Intraoral scanners provide their own illumination during scanning, referred to herein as internal illumination. However, light not provided by the intraoral scanner such as from lights of a dentist's chair, room lights, and/or sunlight (referred to herein as external illumination) may also illuminate the patients' oral cavity. Depending on whether there is external illumination and the amount and type of external illumination, the color of the patient's gingiva, teeth, etc. that is captured may vary. Such variance in the captured color may cause the color of manufactured dental prosthetics to not match the true color of the patients' teeth. Additionally, external illumination may cause motion blur in captured images, which may reduce image quality and the quality of 3D models generated from captured images.

### SUMMARY

In a first aspect of the disclosure, a method of intraoral imaging comprises: projecting first light having a known first intensity at one or more first wavelengths onto a dental object; capturing one or more first images of the dental object illuminated by the first light; determining a captured first intensity of the one or more first images at one or more second wavelengths; estimating an amount of external illumination based at least in part on the known first intensity at the one or more first wavelengths and the captured first intensity at the one or more second wavelengths; and performing an action based on the estimated amount of external illumination.

In a second aspect of the disclosure, method of intraoral scanning comprises: projecting first light having a known first intensity onto a dental object; capturing one or more first images of the dental object illuminated by the first light; determining a captured first intensity of the one or more first images; projecting second light having a known second intensity onto the dental object, wherein there is a known first difference between the second intensity and the first intensity; capturing one or more second images of the dental object illuminated by the second light; determining a captured second intensity of the one or more second images; estimating an amount of external illumination based at least in part on the known first intensity, the known second intensity, the captured first intensity and the captured second intensity; and compensating for the estimated amount of external illumination.

In a third aspect of the disclosure, a method of intraoral imaging comprises: capturing one or more images of a dental object illuminated by light having one or more first wavelengths; determining a captured intensity of the one or more images at a second wavelength that is not included in the one or more first wavelengths; estimating an amount of external illumination based on the captured intensity of the one or more images at the second wavelength; and performing an action based on the estimated amount of external illumination.

In a fourth aspect of the disclosure, an intraoral scanning system comprises: an intraoral scanner comprising: one or more structured light projectors configured to project structured light comprising a light pattern; one or more non-structured light projectors configured to project non-structured light; and one or more cameras configured to capture intraoral scan data comprising one or more images of a dental object illuminated by at least one of the one or more structured light projectors or the one or more non-structured light projectors. The intraoral scanning system further comprises: a computing device configured to: estimate an amount of external illumination based at least in part on a) a known first intensity at which at least one of the one or more structured light projectors projected the structured light or the one or more non-structured light projectors projected the non-structured light and b) a captured intensity in the one or images of the dental object for one or more color channels; and perform an action based on the estimated amount of external illumination.

In a fifth aspect of the disclosure, an intraoral scanner comprises: one or more structured light projectors configured to project structured light comprising a light pattern; one or more non-structured light projectors configured to project non-structured light; one or more cameras configured to capture intraoral scan data comprising one or more images of a dental object illuminated by at least one of the one or more structured light projectors or the one or more non-structured light projectors; and one or more processing device configured to: estimate an amount of external illumination based at least in part on a) a known first intensity at which at least one of the one or more structured light projectors projected the structured light or the one or more non-structured light projectors projected the non-structured light and b) a captured intensity in the one or images of the dental object for one or more color channels; and perform an action based on the estimated amount of external illumination.

### BRIEF DESCRIPTION OF THE DRAWINGS

The present disclosure is illustrated by way of example, and not by way of limitation, in the figures of the accompanying drawings.

FIG. 1 illustrates an intraoral scanner comprising a one or more light projectors and a plurality of cameras in the presence of external illumination, in accordance with embodiments of the present disclosure.

FIGS. 2A-B are images of dental objects captured without external illumination, as generated by a camera of the intraoral scanner of FIG. 1, in accordance with embodiments of the present disclosure.

FIGS. 2C-D are images of dental objects captured with external illumination from the sun, as generated by a camera of the intraoral scanner of FIG. 1, in accordance with embodiments of the present disclosure.

FIGS. 2E-F are images of dental objects captured with external illumination from a dentist chair light, as generated by a camera of the intraoral scanner of FIG. 1, in accordance with embodiments of the present disclosure.

FIGS. 3A-B are 3D models of dental arches generated using images captured without external illumination, as generated by a camera of the intraoral scanner of FIG. 1, in accordance with embodiments of the present disclosure.

FIGS. 3C-D are 3D models of dental arches generated using images captured with external illumination from the sun, as generated by a camera of the intraoral scanner of FIG. 1, in accordance with embodiments of the present disclosure.

FIGS. 3E-F are 3D models of dental arches generated using images captured with external illumination from a dentist chair light, as generated by a camera of the intraoral scanner of FIG. 1, in accordance with embodiments of the present disclosure.

FIG. 4 is a timing diagram showing the timing of image capture of a camera in an intraoral scanner that uses a rolling shutter, in accordance with one embodiment.

FIG. 5A is a block diagram showing frames captured by cameras of an intraoral scanner using a first frame rate, in accordance with one embodiment.

FIG. 5B is a block diagram showing frames captured by cameras of an intraoral scanner using a second frame rate, in accordance with one embodiment.

FIG. 6 illustrates a flow diagram for a method of addressing external illumination during intraoral scanning, in accordance with embodiments of the present disclosure.

FIG. 7A illustrates a flow diagram for a method of addressing external illumination during intraoral scanning, in accordance with embodiments of the present disclosure.

FIG. 7B illustrates a flow diagram for a method of addressing external illumination during intraoral scanning, in accordance with embodiments of the present disclosure.

FIG. 7C illustrates a flow diagram for a method of adjusting images output to a display to compensate for fluctuating intensity of projected light, in accordance with embodiments of the present disclosure.

FIG. 8 illustrates a flow diagram for a method of addressing external illumination during intraoral scanning, in accordance with embodiments of the present disclosure.

FIG. 9 illustrates a flow diagram for a method of addressing external illumination during intraoral scanning, in accordance with embodiments of the present disclosure.

FIG. 10 illustrates one embodiment of a system for performing intraoral scanning and generating a virtual 3D model of a dental arch.

FIG. 11 is a schematic illustration of a wand (e.g., intraoral scanner) with a plurality of structured light projectors and cameras disposed within a probe at a distal end of the wand, in accordance with embodiments of the present disclosure.

FIG. 12 is a chart depicting a plurality of different configurations for the position of the structured light projectors and the cameras in the probe of FIG. 11, in accordance with embodiments of the present disclosure.

FIG. 13 illustrates a block diagram of an example computing device, in accordance with embodiments of the present disclosure.

FIG. 14 illustrates a technique for using interpolation and/or averaging across multiple images to account for changes in a relationship between a camera and an imaged object between images captured using first illumination and images captured using second illumination, in accordance with embodiments of the present disclosure.

### DETAILED DESCRIPTION

Described herein is a method and apparatus for improving the quality of intraoral scans, images and three-dimensional (3D) models of dental objects such as teeth, gingiva, dental arches, etc. as generated by an intraoral scanner. In particular, embodiments provide an intraoral scanning system that identifies and/or compensates for external illumination (i.e., illumination from sources external to the intraoral scanning system). In some embodiments, an intraoral scanner includes one or more structured light projectors, one or more non-structured light projectors, and one or more cameras. The structured light projectors and non-structured light projectors are each configured to project structured or non-structured light onto a dental object (e.g., an oral structure such as a tooth, gingiva, dental arch, or portion thereof). The cameras are configured to image the dental site illuminated by the structured and/or non-structured light. In an example, the light projectors and cameras may be arranged at or near a tip (e.g., distal end) of the intraoral scanner while keeping the tip of the intraoral scanner to a minimum size and height.

Intraoral imaging (also referred to herein as intraoral scanning) may be performed under multiple different lighting conditions. For example, intraoral imaging may be performed in a dark room, in a room lit by room lighting (e.g., from incandescent, fluorescent and/or light emitting diode (LED) lights), in a room lit by a dentist chair light, in a room light by sunlight through a window, and so on. Each of these lighting conditions may affect the colors and shading of captured images. For example, the colors of teeth and gingiva imaged in a dark room may be different from the colors of teeth and gingiva imaged in the presence of sunlight. These color differences can make it challenging to determine the proper coloration of dental prosthetics. For images generated for the purpose of determining accurate coloration of a patient's teeth (referred to as shade taking), the impact of external illumination is particularly important. Embodiments address these challenges by determining information about external illumination, and then performing one or more actions to address the identified external illumination. For example, processing logic may process captured images to determine an amount of external illumination, to determine whether there is excessive external illumination, to determine a color profile of external illumination, and so on. In some embodiments, processing logic determines a contribution of external illumination to the color in captured images, and compensates for the color contribution provided by the external illumination. In some embodiments, processing logic determines whether an amount of external illumination exceeds a threshold, and outputs a warning when the amount of external illumination exceeds the threshold. For example, for general imaging (e.g., intraoral scanning), the overall target color accuracy may be a true color+/−5%. To achieve such color accuracy, the external illumination threshold of 1% external illumination may be used. For shade taking, an overall target color accuracy may be a true color+/−1%. To achieve such an accuracy, an external illumination threshold of ⅓% or ⅕% may be used. Embodiments improve the color accuracy of images captured in the presence of external illumination. In embodiments, intraoral images and 3D models may have coloration that is accurate to within 5%, to within 1%, or better of true color of a dental object by applying the techniques described herein.

Embodiments described herein provide multiple techniques for overcoming external illumination. The techniques for overcoming external illumination may be used singly or in combination in embodiments. Embodiments provide improved techniques for generating 3D modes of dental arches that take advantage of large field of view (FOV) and/or large ranges of depths of focus while compensating for external illumination.

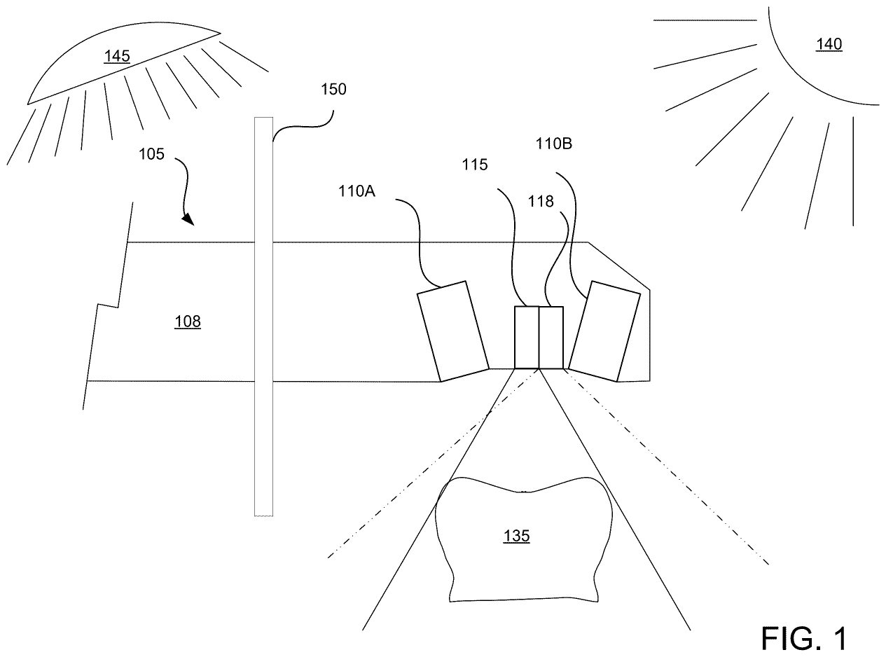

Turning now to the figures, FIG. 1 illustrates an intraoral scanner 105 comprising one or more structured light projectors 115, one or more non-structured light projectors 118 and a plurality of cameras (e.g., cameras 110A, 110B). Intraoral scanner 105 includes a wand 108 and a probe at a distal end of the wand 108. The cameras 110A-B and light projectors 115, 118 may be disposed in the probe along a longitudinal axis of the probe (e.g., along a longitudinal axis of the intraoral scanner and/or wand), such as at a distal end of the probe and/or wand as shown. For ease of illustration one structured light projector 115, one non-structured light projector 118 and two cameras 110A-B are shown along the longitudinal axis. However, it should be understood that the intraoral scanner 105 may include two or more structured light projectors, two or more non-structured light projectors (e.g., one or more white light projectors, one or more infrared or near-infrared (NIR) light projectors, etc.) and/or four or more cameras.

In some embodiments, the cameras 110A-B and structured light projector(s) 115 (and optionally non-structured light projector(s) 118) are arranged in one or more component groupings, which may be referred to as scan units. For example, a first scan unit may include structured light projector 115 and cameras 110A-B, and a second scan unit may include a second structured light projector (not shown) and additional cameras (not shown). In some embodiments, each scan unit includes a single structured light projector and four or more cameras disposed about the structured light projector. For example, each scan unit may include a camera on either side of the structured light projector along the longitudinal axis of the probe and a camera on either side of the structured light projector along the transverse axis of the probe. In embodiments, all cameras and all light projectors (e.g., all scan units) are positioned to face directly towards an object to be scanned. For example, the structured light projectors and cameras may be positioned approximately orthogonal to the longitudinal axis of the probe (e.g., within 35 degrees of orthogonal to the longitudinal axis). In some embodiments, all cameras and all structured light projectors (e.g., all scan units) are positioned to face a mirror (not shown) in the probe, and the mirror reflects projected light onto an object to be scanned and projects captured light from the object to be scanned back to the cameras. For example, the structured light projectors and cameras may be positioned approximately parallel to the longitudinal axis of the probe (e.g., within 35 degrees of parallel to the longitudinal axis). In some embodiments, some (e.g., one or more) cameras and/or structured light projectors (e.g., scan units) are positioned to directly face an object to be scanned while other cameras and/or structured light projectors (e.g., scan units) are positioned to face a mirror within the probe of the intraoral scanner 105.

As shown, a dental object 135 (e.g., such as a tooth, dental arch portion, intraoral surface, etc.) is within a field of illumination (FOI) of structured light projector 115 and within a field of illumination of non-structured light projector 118. Additionally, the dental object 135 is within a field of view (FOV) of the cameras 110A-110B. Cameras 110A-B may capture images of the dental object 135 while the dental object 135 is illuminated by one or more structured light projectors 115 and/or while the dental object 135 is illuminated by one or more non-structured light projectors 118. Depending on an imaging mode, different light projectors may project light for a given frame captured by cameras 110A-B at different times, and cameras 110A-B may capture images of the dental object 135 having the respective illumination. For example, intraoral scanner 105 may alternate between frames captured while structured light is projected, frames captured while white non-structured light is projected and/or frames captured while NIR non-structured light is projected. Images captured while structured light is projected (referred to a structured light images) may be usable to determine 3D information about points on the 3D object and ultimately to generate a 3D point cloud (e.g., an intraoral scan). Images captured while NIR light is projected may be two-dimensional (2D) NIR images. Images captured while white light is projected may be 2D color images. In some embodiments, the structured light projectors project structured white light, which may be usable to generate a 3D point cloud with color information (e.g., for surface texturing).

Any of the aforementioned intraoral images (e.g., images captured during structured light projection, during white light projection, during NIR light projection, etc.) may be captured in the presence of external illumination. The type, color profile, intensity, etc. of external illumination may be highly variable, and may be unknown to the intraoral scanning system.

External illumination is different in many ways from internal illumination. External illumination may vary in spectrum (e.g., internal white LED (WLED) spectrum vs. tungsten lamp or day light spectrum near a window). External illumination may vary in in power distribution, distance, and angles. For example, WLED point sources near cameras have a different power distribution, distance and angles compared to diffused light from a window or room, or compared to dental chair projected light. Additionally, external illumination may strobe according to some frequency (e.g., 50 or 60 Hz for fluorescent lighting) or may be continuous (e.g., such as for daylight). These variations in external illumination can make it difficult to account for the external illumination, which may be unknown and uncalibrated. In contrast, in embodiments, internal illumination is known, calibrated and predicted.

This unknown external light affects each of the types of images that might be captured by the intraoral scanner 105. For example, in some instances intraoral imaging may be performed near a window that permits external illumination from the sun 140. In some instances, intraoral imaging may be performed in a room illuminated by a dentist chair light 145. In some instances, intraoral imaging may be performed in a room illuminated by room lights (not shown). In some instances, intraoral imaging may be performed by two or more of the above external lighting sources. In some instances, intraoral imaging may be performed in a dark room. Each of these conditions may cause different color data to be captured. In embodiments, intraoral scanner 105 and/or an intraoral scanning system that includes intraoral scanner 105 is capable of identifying the presence of external illumination and performing one or more actions to compensate for the external illumination and/or otherwise address the external illumination.

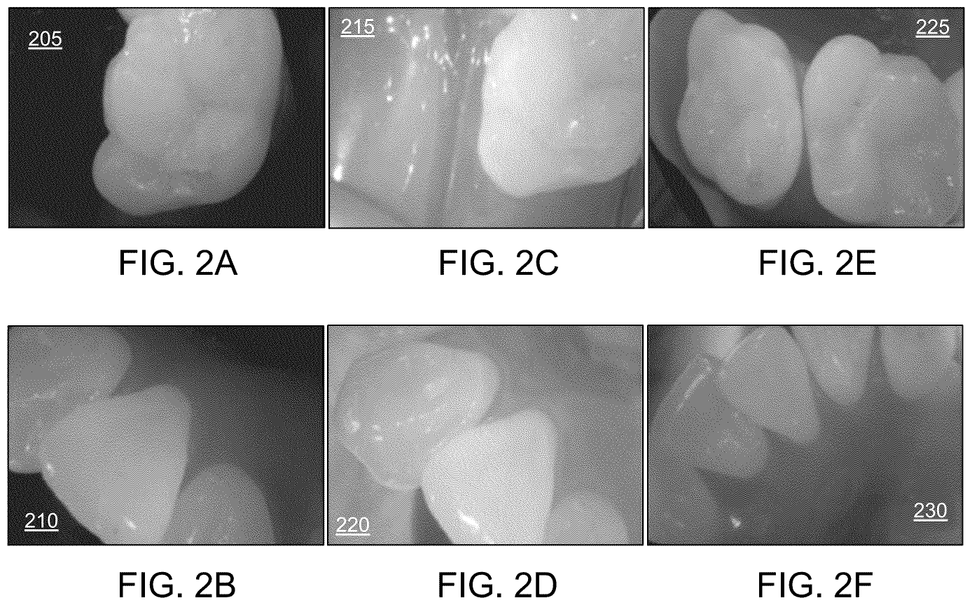

FIGS. 2A-F are images of dental objects captured under different lighting conditions. FIGS. 2A-B are images 205, 210 of dental objects captured without external illumination, as generated by a camera of the intraoral scanner of FIG. 1, in accordance with embodiments of the present disclosure. FIGS. 2C-D are images 215, 220 of dental objects captured with external illumination from the sun, as generated by a camera of the intraoral scanner of FIG. 1, in accordance with embodiments of the present disclosure. FIGS. 2E-F are images 225, 230 of dental objects captured with external illumination from a dentist chair light, as generated by a camera of the intraoral scanner of FIG. 1, in accordance with embodiments of the present disclosure. As shown images 205-210 are darker than images 215-230, and gingiva is barely visible in images 205-210. Images 215-220 are brighter than images 205-210 and images 225-230. Images 225-230 has intermediate brightness as compared to images 205-210 and images 215-220. Additionally, the tooth coloration and shading is different between images 205-210, images 215-220 and images 225-230. This can be problematic for determining the coloration of a dental prosthetic to be installed in the patient's oral cavity.

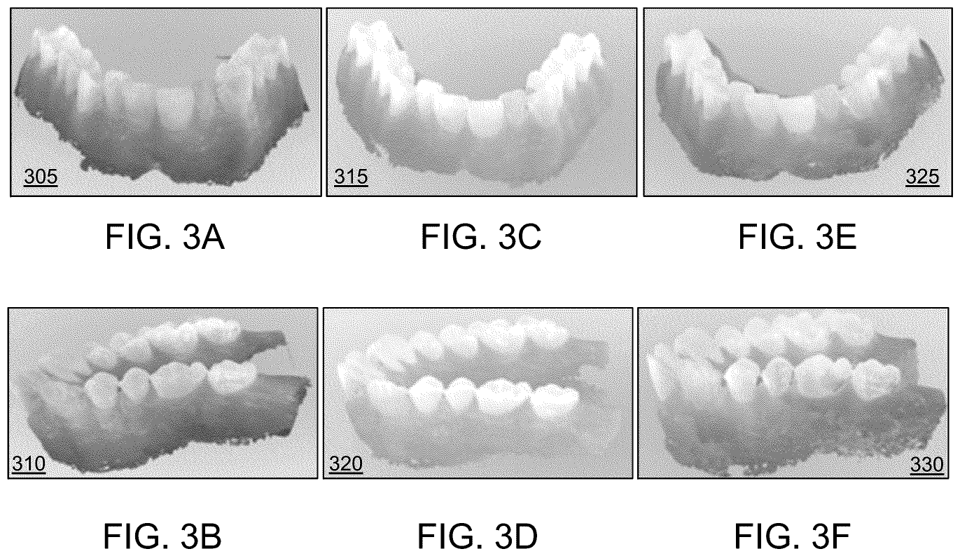

FIGS. 3A-F are 3D models of dental arches generated using image data captured under different lighting conditions. During intraoral scanning, intraoral scanner 105 may alternate between capturing of intraoral scans (e.g., 3D point clouds), which in some embodiments include depth information but lack color information, and color 2D images. The intraoral scans may be registered and stitched together to form 3D models of dental arches, and the color information from the 2D images may be mapped to the 3D models as textures to apply color to the 3D models. External illumination may affect the colors in the captured 2D color images, which ultimately affects the colors of the 3D models. Additionally, in some embodiments, structured light images can be quite dark. Accordingly, structured light images are also affected by external light as well. For example, structured light in the blue or green wavelengths may be used, and structured light in the red wavelengths may not be used. However, redness may be observed in the lip region despite no red energy being present in the green and blue structured light projectors, indicating that external light has affected the image. This may slightly reduce capturability in some conditions.

FIGS. 3A-B are 3D models 305, 310 of dental arches generated using images captured without external illumination, as generated by a camera of the intraoral scanner of FIG. 1, in accordance with embodiments of the present disclosure. FIGS. 3C-D are 3D models 315, 320 of dental arches generated using images captured with external illumination from the sun, as generated by a camera of the intraoral scanner of FIG. 1, in accordance with embodiments of the present disclosure. FIGS. 3E-F are 3D models 325-330 of dental arches generated using images captured with external illumination from a dentist chair light, as generated by a camera of the intraoral scanner of FIG. 1, in accordance with embodiments of the present disclosure. The effects of different lighting that are observed in images 205-230 can be observed in 3D models 305-330.

Multiple different techniques for addressing and/or compensating for external illumination are discussed below. These interference compensation techniques may be applied singly and/or in any combination in embodiments.

One solution to addressing external illumination is to increase a frame rate of the cameras. This reduces an exposure time that the cameras are exposed to external illumination, reducing an impact of external illumination. Increasing the frame rate provides multiple benefits, including reducing motion smear and reducing an impact of external illumination on captured color information.

In some embodiments, a light projector 115, 118 projects light having one or more first wavelengths (e.g., blue light, red light, green light, infrared light, etc.). Cameras 110A-B may include filters (e.g., color filters, dichroic filters, etc.) that block light having wavelengths that are outside of the wavelength(s) of the projected light and/or that permit light having the wavelength(s) of the projected light. In the case of projected white light (e.g., by non-structured light projector 118 and/or structured light projector 115), the cameras 110A-B may include one or more narrow band color filters matched to wavelengths output by at least one of the structured light projector(s) 115 or the non-structured light projector(s) 118. Any of these filters may reduce an amount of external illumination that reaches the image sensors of the cameras, reducing an impact of the external illumination.

In some embodiments, light projector(s) 115, 118 project polarized light (or a polarization filter is positioned in front of one or more of the light projector(s) 115, 118 to apply polarization to projected light. Additionally, polarization filters having a polarization that matches a polarization of the projected light may be positioned in front of camera(s) 110A-B. Such polarization filters may filter out a portion of the external light that has other polarization, reducing an effect of the external illumination.

In some embodiments, dark filters may be positioned in front of camera(s) 110A-B. Such dark filters may reduce an intensity of light received by the image sensors of the cameras, reducing an amount of external illumination that is captured. By adding dark filters, this enables an intensity at which light projectors 115, 118 project light to be increased without saturating pixels of the camera's image sensors.

In some embodiments, a light blocking device 150 is attached to the wand 108 of intraoral scanner 105. The light blocking device may be composed of a plastic, resin, metal, and/or other material. The light blocking device 150 may block at least a portion of the external illumination from entering an oral cavity during intraoral scanning. In some embodiments, the light blocking device blocks some wavelengths of light and permits other wavelengths of light. This may cause the light blocking device to be at least partially transparent so that a dental practitioner can see through the light blocking device during intraoral imaging. In some embodiments, the light blocking device 150 is removable from the intraoral scanner 105. For example, if the dentist is working without a dental chair light, he may not need the light blocking device and may remove it from the intraoral scanner 105. Even in cases where there is a dental chair light, the doctor might decide to use the light blocking device only when scanning some areas of the mouth that are more affected by external light (for example the incisors) and choose not to use the light blocking device when scanning other areas (such as the molars).

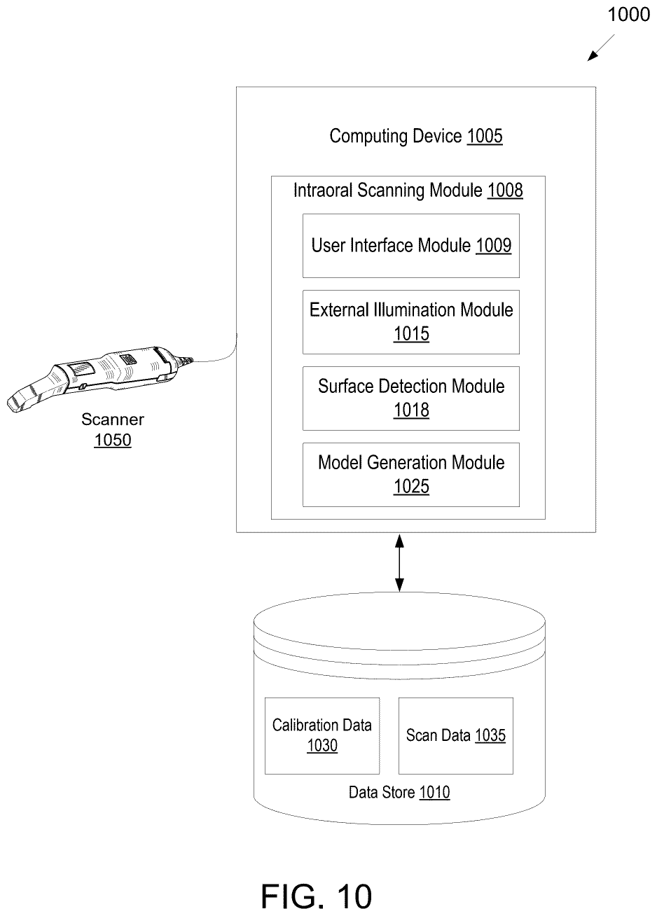

In some embodiments, one or more processing devices (e.g., one or more processors) of the intraoral scanner 105 and/or of a computing device connected to intraoral scanner 105 (e.g., computing device 1005 of FIG. 10) process images captured by intraoral scanner 105 to detect external illumination, and perform one or more actions based on the detected external illumination. In some embodiments, processing logic alternates the power (e.g., intensity) of light output by light projectors 115, 118, and uses the alternating power and captured light intensity values to detect an amount of external illumination. In some embodiments, processing logic detects a light intensity in one or more wavelengths that are not projected by light projector(s) 115, 118, and determines an amount of external illumination based on the light intensity in the one or more wavelengths. In an example, processing logic may determine an amount or level of external illumination, and may output a warning and/or perform another action responsive to determining that the amount or level of external illumination exceeds a threshold. In another example, processing logic may determine properties of the external illumination and may compensate for the external illumination based on the determined properties of the external illumination. Other actions may also be performed based on the amount of detected external illumination.

In some embodiments intraoral scanner 105 may increase an intensity of light output by light projectors 115, 118, such as when external illumination is detected or as a default. This may be accompanied by reducing a gain of the cameras 110A-B. If the amount of internal light is increased, the effect of the external light reduces significantly as the internal light source is much closer to the target than the external source. By reducing the sensor gain (e.g., from 3 to 1), the intraoral scanner can increase the amount of light output by light projectors 115, 118 without oversaturating generated images. This can be achieved, for example, for a WL LED using a higher current. In some embodiments, the intraoral scanner is designed to always use the higher intensity light projection and to use the reduced gain, regardless of whether external illumination is detected.

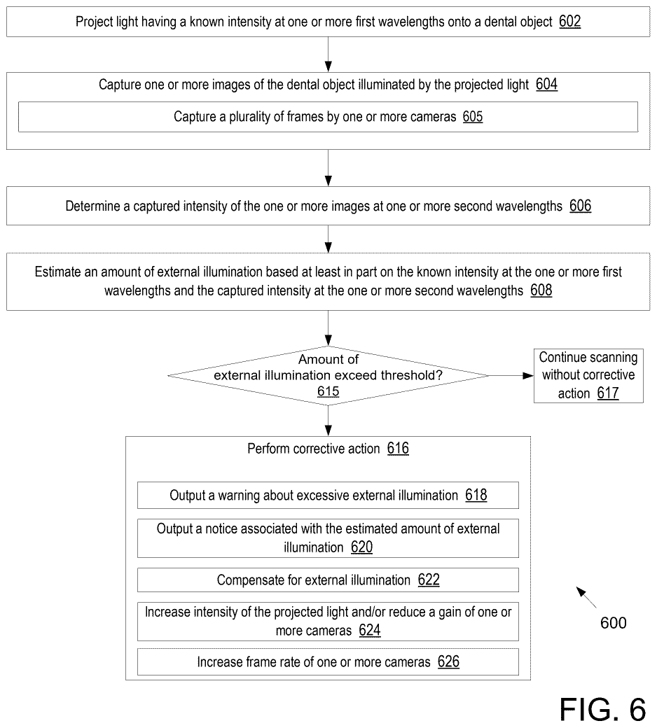

Techniques for detecting and responding to external illumination are described in greater detail below with reference to FIGS. 6-9.

Cameras 110A-B may be global shutter cameras (cameras with global shutter image sensors) or rolling shutter cameras (cameras with rolling shutter image sensors). In a global shutter camera, the entire image sensor of the camera captures a scene simultaneously. This means that all pixels of the image sensor are exposed to light and/or read at the same time. As a result, there is typically less motion smear or artifacts caused, for example, by fast motion. However, global shutter sensors tend to be larger, more complex and more expensive to manufacture compared to rolling shutter sensors. Additionally, global shutters have larger pixels than rolling shutters, which forces a compromise between resolution and sensor size. Global shutter cameras also have larger difference between pixels (PRNU) to be compensated for than rolling shutters.

In one embodiment, one or more global shutter cameras may be used. With a global shutter camera, the image sensor only captures light during strobe illumination, drastically reducing an amount of exposure to external light. The use of global shutters may reduce an impact of external illumination. Using a global shutter provides multiple benefits, including reducing motion smear and reducing an impact of external illumination on captured color information. However, global shutter image sensors are larger and more complex than rolling shutter image sensors.

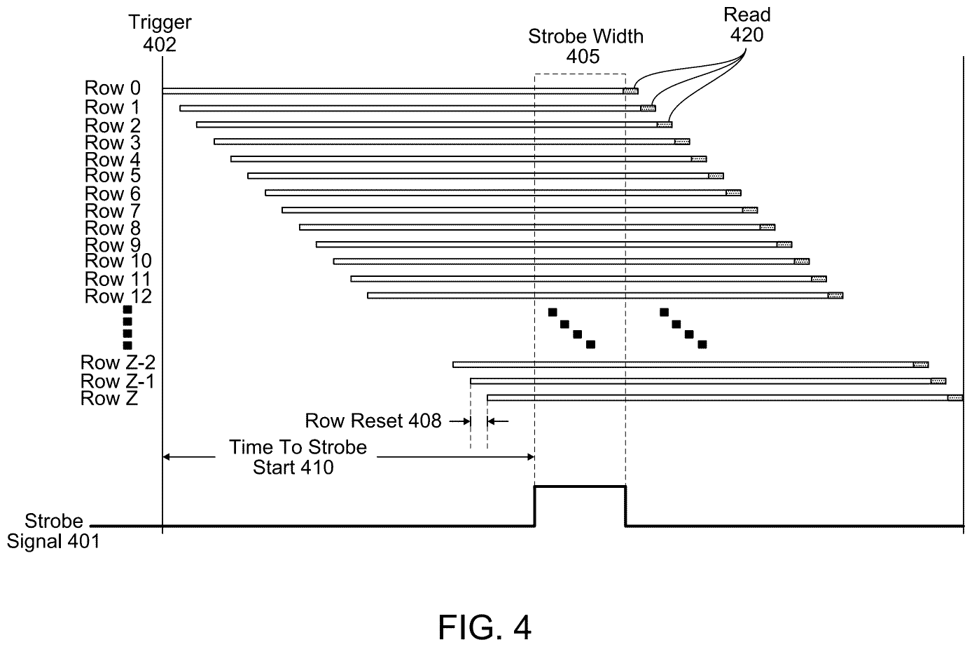

FIG. 4 is a timing diagram showing the timing of image capture of a camera in an intraoral scanner that uses a rolling shutter, in accordance with one embodiment. In a rolling shutter camera, pixels of an image sensor collect light continuously and the image sensor captures the scene by scanning pixels of the image sensor line by line from top to bottom (or vice versa) over a brief period. This means that each line of the image is exposed at a slightly different time and/or read at a slightly different time. Consequently, if there is any change in the scene during the exposure and/or before pixel values are read, it can lead to distortion or artifacts in the final image. For example, fast-moving objects may appear skewed or bent. Additionally, light from external illumination may accumulate on pixels in rows of the image sensors over time until the rows of the image sensors are read.

As shown, different rows (e.g., rows 0 through z) of an image sensor with a rolling shutter are triggered 402 and reset 408 at different times. After a row of pixels is read, it is reset 408, and starts collecting light again. In embodiments, a strobing mechanism is used to provide a strobe signal 401 and to illuminate the image sensor at a time when all rows are exposed.

Once all rows have been reset, a light projector 115, 118 may output light at an appropriate time according to strobe signal 401. The light may be output for a set amount of time according to strobe width 405 during which the image sensors are capturing light output by the light projector(s) 115, 118. In one embodiment, the strobe illumination (i.e., strobe width 405) is short, such as about 1 millisecond (msec) for an unstructured light projector (e.g., white LED) that emits a white light and for a structured light projector (e.g., green laser) that emits coherent light. In one embodiment, the strobe width is about 2 msec for a structured light projector (e.g., blue laser) that emits coherent light.

The rows are then read one at a time. Though the image sensors are only exposed to the internal illumination of the light projectors 115, 118 for the strobe duration, pixels in rows of the image sensors are exposed to any external illumination up until the rows of the image sensors are read. This means that even though external illumination may be much less intense than the internal illumination, since the image sensors are exposed to the external illumination for a longer time than the internal illumination the effect of the external illumination on captured images can be significant. In some embodiments, the effect of the external illumination can be reduced by increasing the frame rate of the image sensors, which may reduce the amount of time between resetting a row and reading the row.

For a frame rate of 60 frames per second (fps), each row of pixels is exposed for 16.6 msec. External light is collected during the entire exposure time, whereas the internal light is collected only during the short strobe pulse (e.g., 1-2 msec). A side effect of this long exposure time is motion blur, which can be seen when there is too much external light. The amount of the external light effect is related to the ratio between the external light integrated in the exposure time and the internal light given in the pulse/strobe time (e.g., strobe width 405). Accordingly, by increasing the frame rate the amount of time that each row of pixels Is exposed to external Illumination Is reduced, reducing the overall effect of the external Illumination on the captured Images.

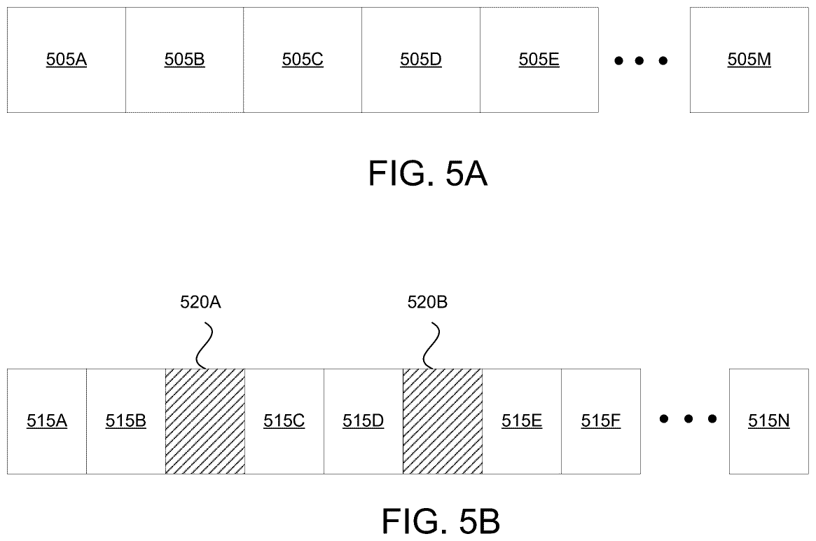

FIG. 5A is a block diagram showing frames 505A-M captured by cameras of an intraoral scanner using a first frame rate, in accordance with one embodiment. In embodiments, the first frame rate may be, for example, 60 frames per second (FPS) or another frame rate. The frame rate may be set to a value that is below a maximum frame rate of the cameras by default. For example, the frame rate may be set to a value that is based on the rate at which image processing is performed on captured images (e.g., to solve a correspondence problem between projected pattern features and captured image features, to determine 3D coordinates of points in captured images, to perform object detection and/or recognition in images, to perform segmentation of images, etc.). However, in embodiments the frame rate may be increased under certain conditions to reduce an effect of external illumination. Alternatively, the frame rate may be set to the higher frame rate by default.

FIG. 5B is a block diagram showing frames 515A-N and frames 520A-B captured by cameras of an intraoral scanner using a second frame rate, in accordance with one embodiment. As shown, due to the increased frame rate, the amount of time used to capture each of the individual frames (exposure time) is decreased and the total number of frames for an image sensor are increased. Using a smaller exposure time will reduce the effect of external light.

In one embodiment, the maximal frame rate in binning mode for cameras 110A-B is 120 fps. However, other cameras having other maximum frame rates may also be used. In embodiments, a shared pulse time is used, and so the maximum achievable frame rate is lower (e.g., below 120 fps), but still higher than the default frame rate (e.g., 60 fps) that may be used under standard lighting conditions (e.g., when excessive external illumination is not detected). By adjusting the frame rate upwards (e.g., to the maximal frame rate), the integration time for the image sensors can be reduced significantly.

For some embodiments, a disadvantage of using a high frame rate is the accompanying high data rate. In some instances, however, a high data rate is acceptable. In some embodiments, the system keeps the same data rate (e.g., number of captured images) even with changes in the frame rate. To achieve a short exposure time of the fast frame rate and still keep the data rate unchanged, a new sensor mode may be introduced for the cameras 110A-B. In the new sensor mode, the cameras 110A-B may alternate between two different frame types. The first frame type (e.g., frames 515A-N) may be standard frames in which data is collected and used to generate images. The second frame type may be a dummy frame 520A-B that is not used to capture data. The dummy frames 520A-B may be used to reset the rows of pixels without recording any information from the rows of pixels. In some embodiments, the dummy frames 520A-B have a different duration than the standard frames. Alternatively, dummy frames may have the same duration as standard frames. The number of dummy frames 520A-B to introduce in the new image mode may be based on a number of additional frames that would be added with the increase in the frame rate. In one embodiment, a first frame will be programed to be a quick dummy frame, just to reset the rows, and a second frame will be the real frame. Together, the dummy frames 520A-B and real frames 515A-N can be programed such that a target frame rate (e.g., of 60 or 77 fps) and a different target data rate (e.g., that is different from the frame rate) are achieved.

FIGS. 6-9 illustrate flow diagrams for methods of detecting and addressing external illumination during intraoral scanning and/or after intraoral scanning (e.g., based on images captured during previous intraoral scanning), in accordance with embodiments of the present disclosure. The methods of FIGS. 6-9 may be performed by processing logic that comprises hardware (e.g., circuitry, dedicated logic, programmable logic, microcode, etc.), software (such as instructions run on a processing device), or a combination thereof. In one embodiment, processing logic corresponds to computing device 1005 of FIG. 10. In one embodiment, processing logic corresponds to a processing device of an intraoral scanner (e.g., a processor in intraoral scanner 105 of FIG. 1). In some embodiments, some aspects of the methods may be performed by an intraoral scanner (e.g., scanner 1050 of FIG. 10), while other aspects of the methods are performed by a computing device that may be operatively coupled to an intraoral scanner (e.g., computing device 1005 of FIG. 10). The computing device may be a local computing device that is connected to the intraoral scanner via a wired connection or via a wireless connection. Alternatively, the computing device may be a remote computing device that connects via a network (e.g., the Internet and/or an intranet) to the intraoral scanner or to a local computing device that is in turn connected to the intraoral scanner. Accordingly, the processing logic may be processing logic of the intraoral scanner and/or of a computing device connected to the intraoral scanner over a wired or wireless connection.

FIG. 6 illustrates a flow diagram for a method 600 of addressing external illumination during intraoral scanning, in accordance with embodiments of the present disclosure. At block 602 of method 600, processing logic causes a light projector of an intraoral scanner to project light (e.g., that may or may not have a known intensity/power) onto a dental object (e.g., onto a dental site such as a surface in an oral cavity). The projected light may have a known intensity for one or more first wavelengths in some embodiments. For example, the projected light may be white light at a known intensity or may be coherent light at one or a few specific wavelengths (e.g., blue light, green light, etc.) with known intensities. The projected light may be structured light comprising a light pattern having projected pattern features or may be non-structured light. The light projector(s) may project structured and/or non-structured coherent light and/or non-coherent (e.g., white) light in embodiments.

At block 604, processing logic causes one or more cameras of the intraoral scanner to image the dental object (e.g., to capture one or more images of the dental object) illuminated by the projected light. In some embodiments, one or more cameras of the intraoral scanner capture multiple frames of images at block 605, each at a different time. For example, a camera may have a frame rate (e.g., of 60-120 frames per second), and may capture a set number of frames in a given time period according to the frame rate. In some embodiments, multiple cameras capture images simultaneously or in parallel. Each of the cameras may capture images at a same frame rate in some embodiments. Accordingly, a sequence of frames of images may be captured by each of a plurality of cameras of the intraoral scanner.

In embodiments, cameras capture intraoral scan data (also referred to as an intraoral scan) that includes a set of images generated at a same time or approximately the same time, each image having been generated by a different camera. Other intraoral scans may also be generated, each including a set of images. Each intraoral scan may include image data generated by multiple cameras of an intraoral scanner. In an example, two or more cameras of an intraoral scanner may each generate an intraoral image, and the multiple intraoral images may be combined based on the known positions and orientations of the respective two or more cameras to form an intraoral scan. In one embodiment, each intraoral scan may include captured image features that correspond to pattern features that were projected onto a region of the dental site/object by one or more structured light projectors. Image features as used herein are features of a light pattern that are captured in an image (as opposed to pattern features, which are features of a projected light pattern as projected). Image features correspond to camera rays, while pattern features correspond to projector rays. For example, one or more structured light projectors may be driven to project a distribution of discrete unconnected spots of light or a checkerboard pattern on an intraoral surface, and the cameras may be driven to capture images of the projection. The image captured by each camera may include image features corresponding to at least one of the pattern features (e.g., projected spots, features of a checkerboard pattern, etc.). Together the images generated by the various cameras at a particular time may form an intraoral scan (e.g., first intraoral scan data). In some embodiments, non-structured light (e.g., non-coherent or white light and/or near-infrared light) is used to illuminate the dental arch/object for some frames, and structured light is used to illuminate the dental arch/object for other frames. For example, the intraoral scanner may alternate between projection of structured light and one or more types of non-structured light.

Each camera may include a camera sensor that has an array of pixels, for each of which there exists a corresponding ray in 3D space originating from the pixel whose direction is towards an object being imaged. Each point may lie along a particular one of these camera rays that, when imaged on the sensor, will fall on its corresponding respective pixel on the sensor. As used throughout this application, the term used for this is a “camera ray.” Similarly, for each projected spot or other feature from each structured light projector there exists a corresponding projector ray. Each projector ray corresponds to a respective path of pixels on at least one of the camera sensors. For example, if a camera sees a spot or other pattern feature projected by a specific projector ray, that spot or pattern feature will necessarily be detected by a pixel on the specific path of pixels that corresponds to that specific projector ray. Values for (a) the camera ray corresponding to each pixel on the camera sensor of each of the cameras, and (b) the projector ray corresponding to each of the projected pattern features from each of the projectors, may be stored as calibration data, as described hereinbelow.

A dental practitioner may perform intraoral scanning of the dental arch to generate a plurality of intraoral scans of the dental arch. This may include performing intraoral scanning of a partial or full mandibular or maxillary arch, or a partial or full scan of both arches. Performing the intraoral scanning may include alternately projecting structured light having a light pattern (e.g., a non-coded structured light pattern) onto an intraoral surface of a patient using a first light projector and projecting non-structured light lacking a light pattern onto the intraoral surface of the patient using a second light projector and/or a third light projector. Performing the intraoral scanning may further include capturing a plurality of scans or images of the projected structured light and non-structured light using one or more cameras disposed in the probe.

At block 606, processing logic determines a captured intensity of the one or more images. In embodiments, processing logic determines the captured intensity for one or more second wavelengths. In one embodiment the one or more first wavelengths correspond to a first and/or second color channel, and the one or more second wavelengths correspond to the first and second color channels as well as a third color channel. For example, the projected light may include projected blue light and/or projected green light, and the captured images may include blue, green and red color channel values. In some embodiments, the one or more second wavelengths include a wavelength not included in the one or more first wavelengths. For example, the one or more first wavelengths may comprise a green light wavelength and a blue light wavelength, and the one or more second wavelengths may comprise a red light wavelength. In some embodiments, the one or more first wavelengths matches or approximately matches the one or more second wavelengths. For example, the projected light may be white light with red, green and blue values, and the captured images may include intensity values for the red, green and blue color channels. In some embodiments, the captured intensity is an average intensity determined for an entire image averaged across all color channels. In some embodiments separate average intensities are determined for each of the color channels (e.g., an average intensity for the green color channel, an average intensity for the blue color channel, and an average intensity for the red color channel). In some embodiments, the captured intensity (or intensities) is/are determined for each pixel or pixel group of the image(s).

At block 608, processing logic estimates an amount of external illumination based at least in part on the known intensity at the one or more first wavelengths and the captured intensity of the one or more second wavelengths.

At block 615, processing logic may compare the determined amount of external illumination to a threshold (e.g., an external illumination threshold/limit). For example, for general imaging (e.g., intraoral scanning), the overall target color accuracy may be a true color+/−5%. To achieve such color accuracy, the external illumination threshold of 1% external illumination may be used. For shade taking, an overall target color accuracy may be a true color+/−1%. To achieve such an accuracy, an external illumination threshold of ⅓% or ⅕% may be used. Processing logic then determines whether the determined amount of external illumination exceeds the external illumination threshold/limit or meets some other external illumination criteria. If the amount of external illumination exceeds the external illumination threshold and/or meets another external illumination criterion, the method continues to block 616. Otherwise, the method proceeds to block 617.

In one embodiment, processing logic determines whether the one or more second wavelengths include a wavelength not included in the one or more first wavelengths (e.g., for red light). Processing logic may determine an intensity of the wavelength not included in the one or more first wavelengths, and may determine an intensity or amount of the external illumination based on the intensity of that wavelength of light. For example, processing logic may determine an average intensity of the red color channel across the pixels of the image. If the intensity of the wavelength not included in the one or more first wavelengths exceeds a threshold, the method may continue to block 616.

In one embodiment, processing logic determines an intensity or amount of the external illumination for each of a plurality of frames captured by a camera. For each frame, processing logic may determine whether the amount of external illumination for that frames exceeds the threshold. Processing logic may then determine whether the number of frames for which the amount of external illumination exceeded the external illumination threshold exceeds a second threshold (e.g., a number of frames threshold). The second threshold may be a threshold number of frames with excessive external illumination within a moving window (e.g., a window of 10 frames, 60 frames, 120 frames, or some other number of frames). For example, if over half of the frames within a moving window showed excessive external illumination (i.e., external illumination at a level that exceeds the external illumination threshold), then the method may proceed to block 616. If the number of frame for which excessive illumination was detected is below the frame threshold, then the method may proceed to block 617. In one embodiment, processing logic determines whether a threshold number of consecutive frames indicate excessive external light. If so, the method proceeds to block 616.

In one embodiment, processing logic determines an intensity or amount of the external illumination for each of a plurality of images captured at a same time by a different camera (e.g., of the images in an image set). For each image, processing logic may determine whether the amount of external illumination for that image exceeds the threshold. Processing logic may then determine whether the number of images for which the amount of external illumination exceeded the external illumination threshold exceeds a second threshold (e.g., a number of cameras threshold). The second threshold may be a threshold number of images with excessive external illumination that is some fraction of the total number of cameras. For example, if over half of the cameras captured an image that showed excessive external illumination (i.e., external illumination at a level that exceeds the external illumination threshold), then the method may proceed to block 616. If the number of frame for which excessive illumination was detected is below the frame threshold, then the method may proceed to block 617.

In one embodiment, processing logic determines, for each camera, and for each frame captured by that camera over a moving window, whether the frame measured excessive external illumination. Processing logic may then determine whether the total number of frames within the moving window across the images captured by the multiple cameras exceeds a threshold. If so, the method may proceed to block 616. Otherwise, the method may continue to block 617.

At block 617, processing logic continues intraoral scanning without corrective action.

At block 616, processing logic performs one or more corrective actions. In one embodiment, performing a corrective action includes, at block 618, outputting a warning about excessive external illumination. This may prompt a doctor to turn off or move a dental chair light (e.g., point it in a different direction), close blinds for a nearby window, dim room lights, and so on.

In one embodiment, performing a corrective action includes, at block 620, outputting a notice associated with the estimated amount of external illumination. For example, processing logic may output a numeric value indicating the level of external illumination that is detected. This may prompt a doctor to turn off or move a dental chair light (e.g., point it in a different direction), close blinds for a nearby window, dim room lights, and so on.

In some embodiments, processing logic determines whether a warning of excess external illumination has been output for a threshold amount of time. If the warning of excess illumination has been output for the threshold amount of time (e.g., without being addressed by the doctor), processing logic may adjust or stop the warning of excess external illumination. For example, processing logic may reduce a size, intensity, loudness, etc. of the warning, may relocate the warning to a side of a display, etc.

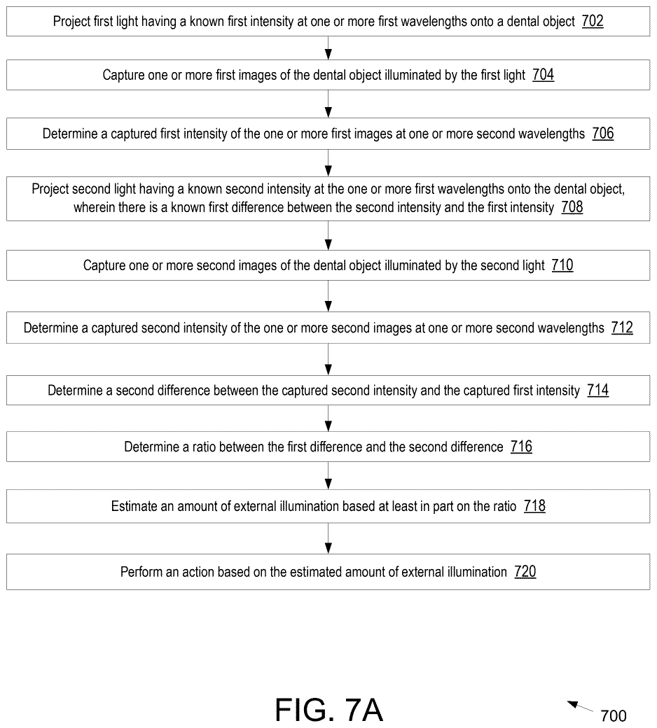

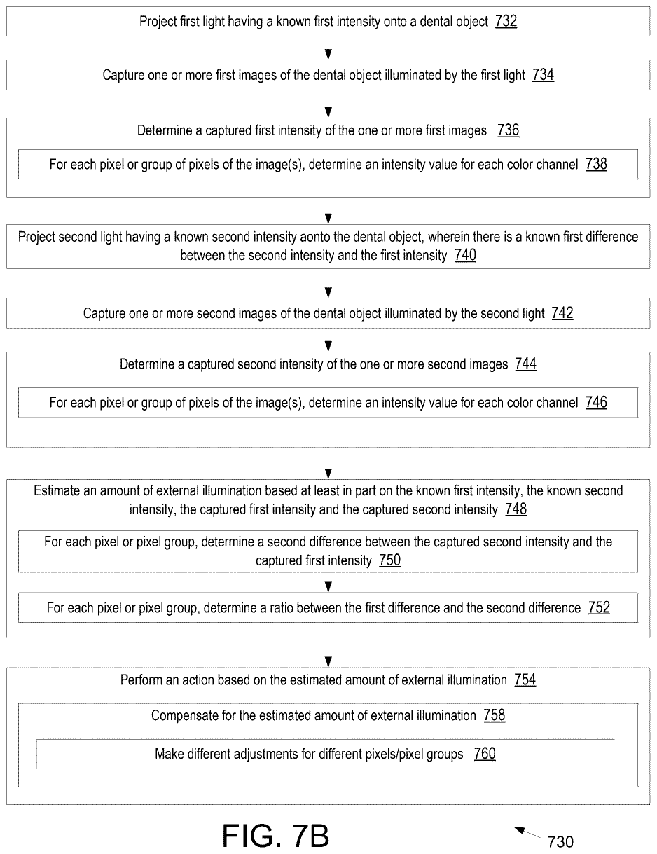

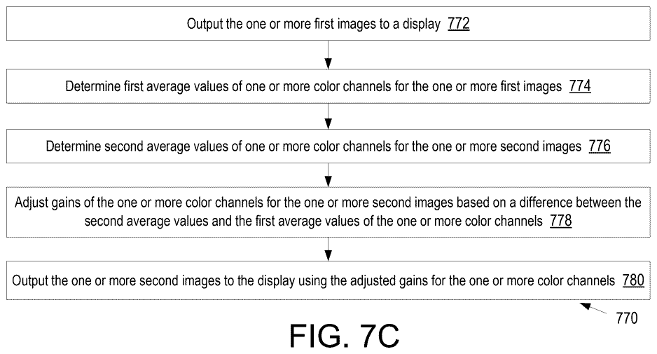

In one embodiment, performing a corrective action includes, at block 622, compensating for the external illumination. In order to compensate for the external illumination, processing logic may estimate levels of external illumination at each color channel and adjust the intensity of pixels or pixel groups for one or more color channels based on the estimated levels of external illumination at those color channels. This technique is described in greater detail below with reference to FIG. 7B.

In one embodiment, performing a corrective action includes, at block 624, increasing an intensity of projected light. This may be accompanied by a corresponding reduction in the gain of the cameras.

In one embodiment, performing a corrective action includes, at block 626, increasing a frame rate of the one or more cameras. In some embodiments, processing logic causes the camera(s) to enter an alternate imaging mode in which some frames are dummy frames that do not produce image data. The number of dummy frames may be selected so that the number of standard frames that do produce image data is unchanged as compared to a standard operating mode of the cameras. This ensures that a data rate of the cameras does not change with the change in frame rate.

In some embodiments, processing logic generates a 3D model based on the intraoral scan data, optionally while compensating for external illumination. Multiple different compensation techniques may be applied to compensate for the external illumination in embodiments. For example, any of the above described interference techniques may be applied.

In one embodiment, a correspondence algorithm is run (optionally using the compensated intraoral scan data). The intraoral scan data may include one or more images from cameras for which excess external illumination was identified and may or may not include one or more images from cameras in which no excess external illumination was identified. The images of the different cameras may have been generated at the same time and may constitute an image set in embodiments. Multiple sets of images may be generated over time, and for each set of images different interference regions for one or more cameras may be determined.

Running the correspondence algorithm may include for each set of images, determining a correspondence between pattern features in the projected pattern of light and image features in the set of images by determining intersections of projector rays corresponding to one or more of the pattern features with camera rays corresponding to the one or more image features (e.g., of the projected pattern) in three-dimensional (3D) space based on calibration data that associates the camera rays corresponding to pixels on the camera sensor of each of the two or more cameras to the projector rays. Running the correspondence algorithm may include first determining the correspondence between the pattern features and the image features in the 3D space for a first subset of the pattern features that are associated with a highest number of image features. Once correspondences have been found for the first subset of the pattern features that are associated with a highest number of image features, processing logic may subsequently determine the correspondence between the pattern features and the image features in the 3D space for a second subset of the pattern features that are associated with a next highest number of image features. This process may be repeated, each time for pattern features associated with a next highest number of image features.

Processing logic may determine depths associated with pattern features based on correspondence to image features in one or more images. The depths may be combined with x,y information also determined from the images to determine 3D coordinates of the pattern features, and thus 3D coordinates of points on a scanned intraoral surface. The depths may be determined using a correspondence algorithm and stored calibration values. The stored calibration values may associate camera rays corresponding to pixels on a camera sensor of each of a plurality of cameras to a plurality of projector rays.

Processing logic may run the correspondence algorithm using the stored calibration values in order to identify a three-dimensional location for each projected point or feature (referred to as a pattern feature) on a surface of a scanned 3D surface (e.g., the first intraoral 3D surface). In one embodiment, for a given projector ray, the processor “looks” at the corresponding camera sensor path on one of the cameras. Each detected image feature along that camera sensor path will have a camera ray that intersects the given projector ray (and thus the pattern feature). That intersection defines a three-dimensional point in space. The processor may search among the camera sensor paths that correspond to that given projector ray on the other cameras and may identify how many other cameras, on their respective camera sensor paths corresponding to the given projector ray, also detected an image feature whose camera ray intersects with that three-dimensional point in space. As used herein throughout the present application, if two or more cameras detect image features whose respective camera rays intersect a given projector ray at the same three-dimensional point in space, the cameras are considered to “agree” on the image feature being located at that three-dimensional point. Accordingly, the processor may identify three-dimensional locations of the projected pattern of light based on agreements of the two or more cameras on there being the projected pattern of light by projector rays at certain intersections. The process is repeated for the additional image features along a camera sensor path, and the image feature for which the highest number of cameras “agree” is identified as the image feature that is being projected onto the surface from the given projector ray (and thus that corresponds to a particular pattern feature). A three-dimensional position on the surface is thus computed for that image feature, including the depth for that image feature. Accordingly, a depth of a first intraoral 3D surface may be determined (which may include depths of multiple different points on the surface of the first intraoral 3D surface).

Once a position on the surface is determined for a specific image feature, the projector ray that projected that image feature, as well as all camera rays corresponding to that image feature, may be removed from consideration and the correspondence algorithm may be run again for a next projector ray. This may be repeated until depths are determined for many or all image features (or there are no remaining image features for which a solution can be found with a threshold level of confidence).

Ultimately, the identified three-dimensional locations may be used to generate a digital three-dimensional model of the intraoral surface. For example, processing logic generates the digital 3D representation of the dental object based on the determined correspondence between the pattern features and the image features in the one or more sets of images. The correspondence algorithm for solving for correspondence between pattern features (e.g., corresponding to projector rays from one or more light projectors) and image features (e.g., corresponding to camera rays from one or more cameras) is described in U.S. application Ser. No. 16/446,181, filed Jun. 19, 2019, which is incorporated by reference herein in its entirety.

Processing logic may stitch together the plurality of intraoral scans. This may include registering the first intraoral scan to one or more additional intraoral scans using overlapping data between the various intraoral scans. In one embodiment, performing scan registration includes capturing 3D data of various points of a surface in multiple intraoral scans, and registering the intraoral scans by computing transformations between the intraoral scans. The intraoral scans may then be integrated into a common reference frame by applying appropriate transformations to points of each registered intraoral scan.

In one embodiment, surface registration is performed for adjacent or overlapping intraoral scans (e.g., successive frames of an intraoral video). Surface registration algorithms are carried out to register two or more intraoral scans that have overlapping scan data, which essentially involves determination of the transformations which align one scan with the other. Surface registration may be performed using, for example, an iterative closest point (ICP) algorithm, and may involve identifying multiple points in multiple scans (e.g., point clouds), surface fitting to the points of each scan, and using local searches around points to match points of the overlapping scans. Some examples of ICP algorithms that may be used are described in Francois Pomerleau, et al., “Comparing ICP Variants on Real-World Data Sets”, 2013, which is incorporated by reference herein. Other techniques that may be used for registration include those based on determining point-to-point correspondences using other features and minimization of point-to-surface distances, for example. In one embodiment, scan registration (and stitching) is performed as described in U.S. Pat. No. 6,542,249, issued Apr. 1, 2003, entitled “Three-dimensional Measurement Method and Apparatus,” which is incorporated by reference herein. Other scan registration techniques may also be used.

Surface registration may include both stitching pairs of intraoral scans sequentially, as well as performing a global optimization that minimizes all pairs of positions together and/or or minimizes all points from all scans one to another. Accordingly, if a scan to scan registration (e.g., using ICP) searches in 6 degrees of freedom (3 translation and 3 rotation) that optimizes the distance of all points from one scan to another, then a global optimization of 11 scans will search in (11−1)×6=60 degrees of freedom for all scans relative to all other scans, while minimizing some distance between all scans. In some cases, this global optimization should give weights to different errors (e.g., edges of scans and/or far points may be given lower weight for better robustness).

A special condition may arise when features (e.g., lines or points) that are less than a surface are to be registered to a surface. Assume that in one scan a feature point of a surface (e.g., a corner of a scan body) is captured, and in another scan the surface that includes the feature point is captured. In the ICP, points from one surface to another are minimized, but the point correspondence step of the ICP can change in each iteration. In a variant algorithm, a fixed correspondence may be found between the feature point (e.g., of a feature of a surface) and the surface points (e.g., of a surface), and try to minimize it together with all the surface minimization. As the feature may be a single point or a few points, and may be overwhelmed by the majority of surface points, the error of this feature point will receive a high weight in the global error.

Processing logic may generate a virtual 3D model of a dental object (e.g., a patient's dental arch) from the intraoral scans by integrating data from all intraoral scans into a single 3D model by applying the appropriate determined transformations to each of the scans. Each transformation may include rotations about one to three axes and translations within one to three planes, for example.

Processing logic may register 2D color images captured while projecting non-structured white light onto the dental arch/object with the 3D model. Based on this registration, color information may be added to the 3D model as a texture. By performing method 600 in generation of the color images, processing logic can ensure that the colors that are mapped to the 3D model are accurate.

For some applications, there is at least one near-infrared light projector that projects near-infrared and/or infrared light onto an object while the object is being scanned. At least one camera captures images of the object using illumination from a near-infrared light projector. Processing logic may run a surface reconstruction algorithm that combines at least one image captured using illumination from structured light projectors with one or more images captured using illumination from a near-infrared light projector in order to generate a digital three-dimensional image of the intraoral three-dimensional surface. Using a combination of structured light and near-infrared illumination enhances the overall capture of the intraoral scanner and may help reduce the number of options that processing logic needs to consider when running the correspondence algorithm. In one embodiment, stereo vision techniques, deep learning techniques (e.g., using convolutional neural networks) and/or simultaneous localization and mapping (SLAM) techniques may be used with the scan data from the structured light and the scan data from the near-infrared light to improve an accuracy of a determined 3D surface and/or to reduce a number of options that processing logic needs to consider when running the correspondence algorithm.

The 3D models of dental arches with improved accuracy (e.g., improved color accuracy) that are provided in embodiments may be useful both for prosthodontic (restorative) and orthodontic procedures. By way of non-limiting example, dental procedures may be broadly divided into prosthodontic (restorative) and orthodontic procedures, and then further subdivided into specific forms of these procedures. The term prosthodontic procedure refers, inter alia, to any procedure involving the oral cavity and directed to the design, manufacture or installation of a dental prosthesis at a dental site within the oral cavity, or a real or virtual model thereof, or directed to the design and preparation of the dental site to receive such a prosthesis. A prosthesis may include any restoration such as crowns, veneers, inlays, onlays, and bridges, for example, and any other artificial partial or complete denture. The term orthodontic procedure refers, inter alia, to any procedure involving the oral cavity and directed to the design, manufacture or installation of orthodontic elements at a dental site within the oral cavity, or a real or virtual model thereof, or directed to the design and preparation of the dental site to receive such orthodontic elements. These elements may be appliances including but not limited to brackets and wires, retainers, clear aligners, or functional appliances.

One way to detect an amount of external illumination is to modulate the amount of light from the internal light source(s) (e.g., light projectors) and compare the amount that the light has been modulated with an amount of variation in light of captured images. For example, processing logic can alternate between a white LED projection from 90% to 100% of regular illumination. Such a technique is described below with reference to FIG. 7A. FIG. 7A illustrates a flow diagram for a method 700 of addressing external illumination during intraoral scanning, in accordance with embodiments of the present disclosure. At block 702 of method 700, processing logic causes a light projector of an intraoral scanner to project first light having a first known intensity for one or more first wavelengths onto a dental object. For example, the projected first light may be white light at a first known intensity or may be coherent light at one or a few specific wavelengths (e.g., blue light, green light, etc.) with first known intensities. The projected first light may be structured light comprising a light pattern having projected pattern features or may be non-structured light. The light projector(s) may project structured and/or non-structured coherent light and/or non-coherent (e.g., white) light in embodiments.

At block 704, processing logic causes one or more cameras of the intraoral scanner to image the dental object to capture one or more first images of the dental object illuminated by the first light. The first images may include images that are usable to determine 3D information of the dental object, which may constitute intraoral scans. The first images may additionally or alternatively include color 2D images and/or NIR images. In some embodiments, one or more cameras of the intraoral scanner capture multiple frames of images, each at a different time. In some embodiments, multiple cameras capture images simultaneously or in parallel. Each of the cameras may capture images at a same frame rate in some embodiments. Accordingly, a sequence of frames of images may be captured by each of a plurality of cameras of the intraoral scanner. The first images may include images that are usable to determine 3D information of the dental object, which may constitute intraoral scans. The first images may additionally or alternatively include color 2D images and/or NIR images.

At block 706, processing logic determines a captured first intensity of the one or more first images at one or more second wavelengths. In one embodiment the one or more first wavelengths correspond to a first and/or second color channel, and the one or more second wavelengths correspond to the first and second color channels as well as a third color channel. For example, the projected first light may include projected blue light and/or projected green light, and the captured images may include blue, green and red color channel values. In some embodiments, the one or more second wavelengths include a wavelength not included in the one or more first wavelengths. In some embodiments, the one or more first wavelengths matches the one or more second wavelengths.

At block 708, processing logic causes the light projector to project second light having a known second intensity for the one or more first wavelengths onto the dental object. For example, the projected second light may be white light at a second known intensity or may be coherent light at one or a few specific wavelengths (e.g., blue light, green light, etc.) with second known intensities. The projected second light may be structured light comprising a light pattern having projected pattern features or may be non-structured light. In embodiments, the second known intensity may be 70%-90% of the first known intensity.

At block 710, processing logic causes one or more cameras of the intraoral scanner to image the dental object to capture one or more second images of the dental object illuminated by the second light. The second images may include images that are usable to determine 3D information of the dental object, which may constitute intraoral scans. The second images may additionally or alternatively include color 2D images and/or NIR images.

At block 712, processing logic determines a captured second intensity of the one or more second images at the one or more second wavelengths.

There may be a known first difference between the second intensity of the second light and the first intensity of the first light. At block 714, processing logic may compare the captured second intensity to the captured first intensity to determine a second difference between the captured second intensity and the captured first intensity. If there were no external illumination, then the second difference would be equal to the first difference. However, as the amount of external illumination increases, the second difference deviates from the first difference by an increasing margin.

In some embodiments, processing logic alternates between projecting the first light and projecting the second light. Processing logic may also cause cameras to capture a sequence of images projected by the alternating first light and second light. For example, every odd image may depict the first light and every even image may depict the second light. In embodiments, processing logic may determine first averages of the captured first intensity from the images captured using the first light and second averages of the captured second intensity from the images captured using the second light. In some embodiments, the second difference may be a difference between the first averages and the second averages. In some embodiments, the second difference is determined for a single color channel. In some embodiments, second differences are determined for each color channel. In some embodiments, the second differences of an average intensity averaged over each pixel and each color channel of the image(s) is determined.

At block 716, processing logic determines a ratio between the first difference and the second difference. At block 718, processing logic estimates or computes the amount of external illumination based at least in part on the determined ratio. In one embodiment, if the ratio is 1:1, then there is not external illumination. If the ratio is less than 1:1 (e.g., 1:2, 1:3, etc.), then there is external illumination.

In an example, tracking some reference surface of the scanned dental object, processing logic can compare the spectrum and brightness between the first and second Images, and estimate the amount of internal and external light it receives based on the comparison. The amount of light In the each of the captured Images may be calculated using the following equation:

I_{M}=I_{I}·R_{S}+I_{E}·R_{S}

Processing logic may measure the surface response in the images using the above equation, where I_{M} is the measured intensity of the image, R_{S} is the surface reflectance, I_{I} is the known amount or intensity of internal light, and I_{E} is the amount or intensity of external light.

Although processing logic does not know the surface reflectance, it can start with the assumption that it is stable. With this setup, If the internal light fluctuates by 10% between successive captures, but the resultant image of surface fluctuates by 5%, processing logic knows that there is a 50% external light coming in. By fluctuating the light intensity of projected light, multiple image intensities are measured, which can be used together with the known amount of light fluctuation to compute the amount of external light Processing logic may modulate I_{I} between two values (e.g., 1.0 and 0.9) relative to a base illumination value I_{IB}, and may operate under the assumption that R_{S} is constant in some embodiments. The following example is set out using values of 1.0 and 0.9. However, the same technique that is described with reference to these values may also be used with other values. If we assume the example values of 1.0 and 0.9, the above equation may be written as follows:

$${I}_{M 1} = 1. \cdot {I}_{I} \cdot {R}_{S} + {I}_{E} \cdot {R}_{S}$$

$${I}_{M 2} = 0.9 \cdot {I}_{I} \cdot {R}_{S} + {I}_{E} \cdot {R}_{S}$$

These equations can be rewritten as:

$${I}_{M 1} = ( 1. \cdot {I}_{I} + {I}_{E} ) \cdot {R}_{S}$$

$${I}_{M 2} = ( 0.9 \cdot {I}_{I} + {I}_{E} ) \cdot {R}_{S}$$

as follows.

Processing logic may divide the internal base illumination I_{IB} by the captured illumination to determine a ratio therebetween, as follows:

$$\frac{{I}_{M 1}}{{I}_{IB}} = ( 1.0 + \frac{{I}_{E}}{{I}_{IB}} ) \cdot {R}_{s}$$

$$\frac{{I}_{M 2}}{{I}_{IB}} = ( 0.9 + \frac{{I}_{E}}{{I}_{IB}} ) \cdot {R}_{s}$$

The external illumination divided by the internal base illumination (I_{E}/I_{IB}) may be defined as f, which is a value that will usually be smaller than 1.

The two above equations can be divided to provide:

$$\frac{{I}_{M 1}}{{I}_{M 2}} = \frac{1 + f}{0.9 + f}$$

To solve for f, this equation can then be rearranged to provide:

$$f = \frac{{I}_{M 2} - 0.9 \cdot {I}_{M 1}}{{I}_{M 2} - {I}_{M 1}}$$

The value of f may be a value that can indicate whether external illumination is too strong. For example, the value of f may be computed, and may be compared to a threshold. If the value of f meets or exceeds the threshold, then processing logic may determine that excessive external illumination is detected. For example, if f is over 0.05 in one implementation, then processing logic may determine that there is too much external illumination.

In some embodiments, processing logic does not account for factors such as change in image and surface area smoothing due to change in angle and direction of view. If the frame rate is fast enough and the intraoral scanner is moved slowly, change in image and surface area may be minimal and can be ignored in some embodiments. Alternatively, processing logic may capture multiple images with the first light being projected and/or multiple images with the second light being projected, and may average over the multiple images to account for changes in the image and/or surface area.

For example, processing logic may use a set of 3 images, wherein the first and third Images use the first amount of Internal Illumination and the second Image uses the second amount of Internal Illumination. Processing logic can use the average of images 1 and 3 and compare it to image 2 for measuring the change in fluctuations. This can also be extended to a sliding window of images which are all averaged before comparison In embodiments.

In one embodiment, processing logic assumes smoothness across measurements, and uses a set of three or more measurements to compute the value of f.

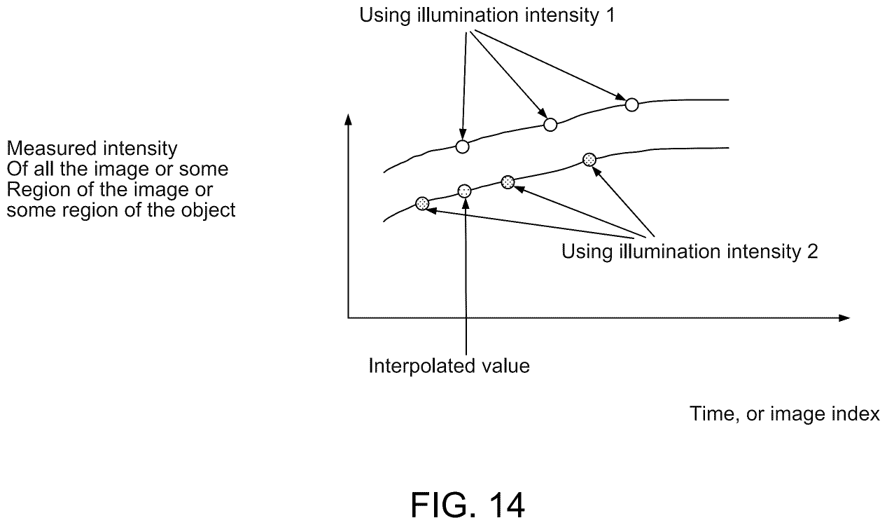

FIG. 14 illustrates a technique for using interpolation and/or averaging across multiple images to account for changes in a relationship between a camera and an imaged object between images captured using first illumination and images captured using second illumination, in accordance with embodiments of the present disclosure. As shown, processing logic may generate multiple images using first illumination (e.g., illumination intensity 1) and may generate multiple images using second illumination (e.g., illumination intensity 2). Since the images are taken at different times, the relative position between the camera generating the images and the imaged object may be different for the different images. For example, the camera and/or patient may move slightly between capture of an image captured using the first illumination and an image captured using the second illumination. To account for these changes, processing logic may interpolate an image under one of the lighting conditions (e.g., an image under the second illumination) based on a first image under that lighting condition that was captured before an image captured under the other lighting condition and a second image under that lighting condition that was captured after the image captured under the other lighting condition. The intensity value(s) of the interpolated image may be used in the above equations to produce a more accurate result in embodiments. Repeating this process of interpolating and comparing every image and averaging can also reduce other noise sources in the estimation.

Returning to FIG. 7A, In some instances, processing logic uses real time images during scanning for presenting in a user Interface (UI) (e.g., as viewfinder Images). In such instances, the fluctuations in the image intensity might annoy a user. To account for this, processing logic may modify the gains of the R, G, and B bands of the images output to a display (e.g., to the UI) to have similar average values across the images even though the intensity of the projected light is fluctuating. This may render the changes in light Intensity on the display unnoticeable to a user.

At block 720, processing logic may perform an action based on the estimated amount of external illumination. For example, in some embodiments processing logic may compensate for the external illumination. This may be performed if amounts of external illumination are determined at a pixel or patch (e.g., group of pixels) level in some embodiments. In some embodiments, processing logic may output a notice or warning if the amount of external illumination that is detected exceeds a threshold level. For example, processing logic may output a warning on the screen or display of the Intraoral scanner and/or a UI of an Intraoral scan application (on a display), may output a voice or audio warning via a speaker of the Intraoral scanner or computing device, may output a small warning on a side of the display In the UI, may cause one or more lights (e.g., LEDs) on the intraoral scanner to flicker or change color, etc. In some embodiments, an option is presented to the user to remove the warning alarm (e.g., the user can insist to continue the scan as is). In some embodiments, after repeated warnings, the system can by default reduce the warning signal or change it to a less obstructive warning. Any of the other aforementioned corrective actions may also be performed responsive to detecting the external illumination levels.

In some embodiments, processing logic generates a 3D model based on the intraoral scan data/images, optionally while compensating for external illumination, as discussed above.

FIG. 7B illustrates a flow diagram for a method 730 of compensating for external illumination during intraoral scanning, in accordance with embodiments of the present disclosure. At block 732 of method 730, processing logic causes a light projector of an intraoral scanner to project first light having a first known intensity onto a dental object. The first light may be, for example, white light projected at a set first intensity or power level. Alternatively, the first light may be coherent light having one or a few set wavelengths at a known first intensity.

At block 734, processing logic causes one or more cameras of the intraoral scanner to image the dental object to capture one or more first images of the dental object illuminated by the first light. The first images may include images that are usable to determine 3D information of the dental object, which may constitute intraoral scans. The first images may additionally or alternatively include color 2D images and/or NIR images.

At block 736, processing logic determines a captured first intensity of the one or more first images. In embodiments, the captured first intensity is determined for each color channel or wavelength or range of wavelengths. For example, a first intensity may be determined for a red color channel, a second intensity may be determined for a green color channel, and a third intensity may be determined for a blue color channel. In one embodiment, at block 738 processing logic determines, for each pixel or group of pixels of the image(s), an intensity value for each color channel. For example, R, G, B values may be determined for each pixel in each of the one or more first images.

At block 740, processing logic causes the light projector to project second light having a known second intensity. The second light may be, for example, white light projected at a set second intensity or power level. Alternatively, the second light may be coherent light having one or a few set wavelengths at a known second intensity. There may be a known first difference between the second intensity and the first intensity in embodiments.

At block 742, processing logic causes one or more cameras of the intraoral scanner to image the dental object to capture one or more second images of the dental object illuminated by the second light. The second images may include images that are usable to determine 3D information of the dental object, which may constitute intraoral scans. The second images may additionally or alternatively include color 2D images and/or NIR images.

At block 744, processing logic determines a captured second intensity of the one or more second images at the one or more second wavelengths. In embodiments, the captured second intensity is determined for each color channel or wavelength or range of wavelengths. For example, a fourth intensity may be determined for a red color channel, a fifth intensity may be determined for a green color channel, and a sixth intensity may be determined for a blue color channel. In one embodiment, at block 746 processing logic determines, for each pixel or group of pixels of the image(s), an intensity value for each color channel. For example, R, G, B values may be determined for each pixel in each of the one or more second images.

At block 748, processing logic estimates an amount of external illumination based at least in part on the known first intensity, the known second intensity, the captured first intensity and the captured second intensity. Such an estimate may be made for each pixel or pixel group, and for each color channel of the pixel or pixel group. Accordingly, different amounts of external illumination may be determined for different color channels of the same pixel and/or for different pixels. In one embodiment, at block 750, for each pixel or pixel group processing logic determines a second difference between the captured second intensity and the captured first intensity. At block 752, for each pixel or pixel group processing logic determines a ratio between the first difference and the second difference. The ratio may indicate the amount of external illumination in embodiments. In embodiments, the amount of external illumination may be calculated as described with reference to FIG. 7A. However, the amount of external illumination may be calculated on a pixel-by-pixel basis or on a pixel group basis rather than for an entire image (as may be done for method 700 in some embodiments).

At block 754, processing logic performs an action based on the estimated amount of external illumination. In one embodiment, at block 758 processing logic compensates for the estimated amount of external illumination at each pixel or pixel group and for each color channel. Compensating for the external illumination may include adjusting the values of one or more color channels for one or more pixels. Different amounts of compensation may be performed for different pixels/pixel groups and for different color channels in embodiments based on the estimated amount of external illumination at those pixels/pixel groups and for those color channels. Accordingly, at block 760 processing logic may make different adjustments to the values of the different color channels of a same pixel. Additionally, different adjustments may be made to different pixels or groups of pixels.

In an example, by using two levels of white LED power in alternating white light frames (e.g., using a light pulse for 0.9 msec in odd frames and for 1 msec in even frames), processing logic can estimate, per region of the dental object surface, the contribution of internal vs. external illumination. It is theoretically possible to separate between the two contributions when building a texture mapping. Consider the simple case when there is no motion or change between frames. Let a be the alternation parameter between the amount of illumination between even and odd frames, which may have a value close to 1 (e.g., 0.9). Let I_{I} be the internal and I_{E} be the external illumination. Let R₁ be an image region of an odd captured frame and R₂ be the image region of an even captured frame in the sequence. Frame 1 is captured with internal light at α, whereas Frame 2 is captured at internal light at 100%. With this information, processing logic can calculate the light in frame 1 and frame 2 as follows:

$${R}_{1} = {Obj}_{I} \cdot {I}_{I} \cdot α + {Obj}_{E} \cdot {I}_{E} \qquad Frame 1$$

$${R}_{2} = {Obj}_{I} \cdot {I}_{I} + {Obj}_{E} \cdot {I}_{E} \qquad Frame 2$$

Where R₁ is the image region in frame one, R₂ is the corresponding image region in frame two, I_{I}, is the internal illumination, I_{E} is the external illumination, α is the alternation parameter of internal illumination between frames 1 and 2, Obj_{E} is _ and Obj_{I} is _.

Solving these questions yields:

$$\frac{{R}_{2} - {R}_{1}}{1 - α} = {Obj}_{I} \cdot {I}_{I}$$

In cases where the intraoral scanner is moving during Image capture, the assumption of a constant image region looking at the same object point may be incorrect. Accordingly, processing logic may use a weaker assumption that between frames, the region of the image looking at the same object is changing smoothly. With such an assumption, processing logic may use three consecutive frames to compute the external illumination for an image region, where processing logic computes an average of the first and third frame for the region. In one embodiment, odd frames use light projector power a and even frames use light projector power 100%.

In some embodiments, processing logic generates a 3D model based on the intraoral scan data/images, optionally while compensating for external illumination, as discussed above. In some embodiments, processing logic uses a texture mapping pipeline to add color information to the generated 3D model as a texture. The position/orientation of the intraoral scanner associated with each captured image may be determined to a high level of accuracy relative to the dental object. Accordingly, processing logic can determine, for each triangular mesh of the object surface, to what images it maps. Processing logic can take the odd frames, and average between them to determine the estimated even frame value (using the smoothness assumption). Replacing the estimated even frame value with the frame 2 in equation above, processing logic can estimate the internal-illumination response.

FIG. 7C illustrates a flow diagram for a method 770 of adjusting images output to a display to compensate for fluctuating intensity of projected light, in accordance with embodiments of the present disclosure. Methods 700 and 730 include alternating internal illumination power or intensity (e.g., by adjusting a strobe duration or changing a power setting of one or more light projectors). The amount that the internal illumination is changing may be small enough that it is not readily apparent to a doctor viewing the patient's mouth as they perform intraoral scanning. However, the alternating internal illumination may cause the colors in the images that are rendered to a display to appear to flicker or otherwise alternate up and down in intensity. Method 770 may be performed to address this issue in embodiments. Method 770 may be performed in conjunction with any of methods 600, 700 and/or 730 in embodiments.

At block 772, processing logic outputs one or more first images to a display (e.g., to a display of computing device 1005 of FIG. 10). The first images may have been captured using first illumination settings for one or more light projectors.

At block 774, processing logic determines first average values of one or more color channels for the one or more first images. Different averages may be determined for each of the color channels in embodiments. Alternatively, a single average may be determined across the color channels. At block 776, processing logic determines second averages of one or more color channels for one or more second images captured using second illumination settings of the one or more light projectors. At block 778, processing logic compares the one or more first average values to the one or more second average values to determine differences therebetween. Processing logic may then adjust gains of the one or more color channels for the one or more second images based on the difference between the second average values and the first average values of the one or more color channels. Different adjustments may be made for each of the color channels in embodiments. Alternatively, a single adjustment may be applied to all color channels.

At block 780, processing logic outputs the one or more second images to the display using the adjusted gains for the one or more color channels. As processing logic alternates between outputting images captured under the first lighting and images captured under the second lighting, for each set of images captured under the second lighting the gains may be adjusted to cause the color values to approximately correspond to the color values of the images captured under the first lighting.

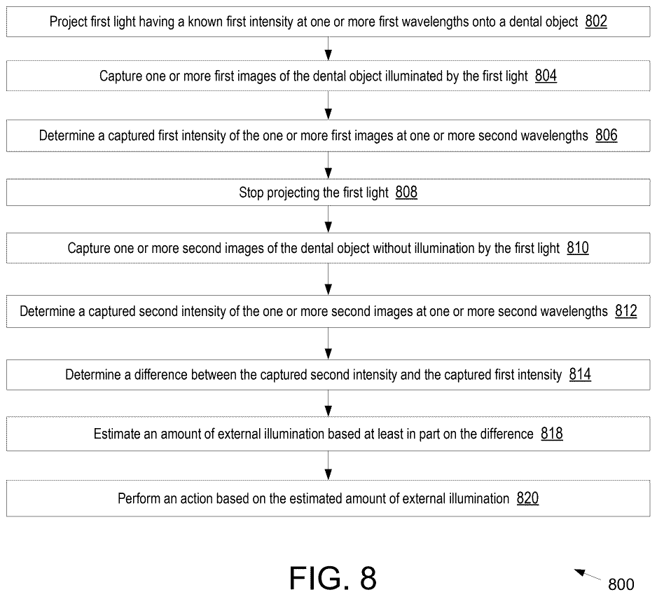

FIG. 8 illustrates a flow diagram for a method of addressing external illumination during intraoral scanning, in accordance with embodiments of the present disclosure. At block 802 of method 800, processing logic causes a light projector of an intraoral scanner to project first light having a first known intensity for one or more first wavelengths onto a dental object.

At block 804, processing logic causes one or more cameras of the intraoral scanner to image the dental object to capture one or more first images of the dental object illuminated by the first light.

At block 806, processing logic determines a captured first intensity of the one or more first images at one or more second wavelengths.

At block 808, processing logic stops projecting the first light.

At block 810, processing logic causes one or more cameras of the intraoral scanner to image the dental object to capture one or more second images of the dental object without illumination by the first light.

At block 812, processing logic determines a captured second intensity of the one or more second images at the one or more second wavelengths.

At block 814, processing logic may compare the captured second intensity to the captured first intensity to determine a difference between the captured second intensity and the captured first intensity.

At block 818, processing logic estimates an amount of external illumination based at least in part on the difference between the captured second intensity and the captured first intensity.

At block 820, processing logic may perform an action based on the estimated amount of external illumination. The action may include any of the aforementioned actions performed based on identified external illumination.

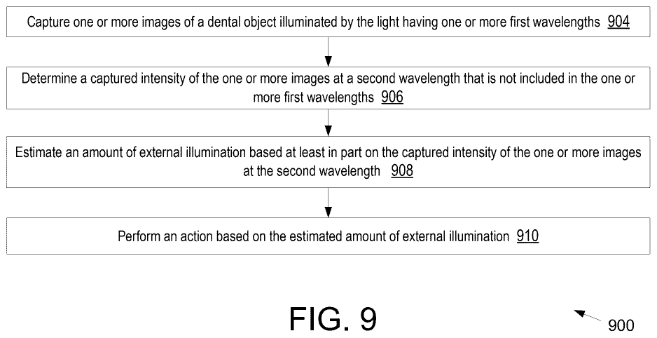

FIG. 9 illustrates a flow diagram for a method 900 of addressing external illumination during intraoral scanning, in accordance with embodiments of the present disclosure. At block 902 of method 900, processing logic causes one or more cameras of an intraoral scanner to capture one or more images of a dental object illuminated by the light having one or more first wavelengths.

At block 906, processing logic determines a captured intensity of the one or more images at a second wavelength that is not included in the one or more first wavelengths. For example, the one or more first wavelengths may not include wavelengths for red, and the second wavelength may be a wavelength for red light.

At block 908, processing logic estimates an amount of external illumination based at least in part on the captured intensity of the one or more images at the second wavelength.

At block 810, processing logic may perform an action based on the estimated amount of external illumination. The action may include any of the aforementioned actions performed based on identified external illumination.

FIG. 10 illustrates one embodiment of a system 1000 for performing intraoral scanning and/or generating a virtual 3D model of a dental arch. In one embodiment, system 1000 carries out one or more operations of above described methods 600, 700, 730, 770, 800 and/or 900. System 1000 includes a computing device 1005 that may be coupled to an intraoral scanner 1050 (also referred to simply as a scanner 1050) and/or a data store 1010. In embodiments, scanner 1050 correspond to scanner 105 of FIG. 1.

Computing device 1005 may include a processing device, memory, secondary storage, one or more input devices (e.g., such as a keyboard, mouse, tablet, and so on), one or more output devices (e.g., a display, a printer, etc.), and/or other hardware components. Computing device 1005 may be connected to a data store 1010 either directly or via a network. The network may be a local area network (LAN), a public wide area network (WAN) (e.g., the Internet), a private WAN (e.g., an intranet), or a combination thereof. The computing device and the memory device may be integrated into the scanner in some embodiments to improve performance and mobility.

Data store 1010 may be an internal data store, or an external data store that is connected to computing device 1005 directly or via a network. Examples of network data stores include a storage area network (SAN), a network attached storage (NAS), and a storage service provided by a cloud computing service provider. Data store 1010 may include a file system, a database, or other data storage arrangement.

In some embodiments, a scanner 1050 for obtaining three-dimensional (3D) data and/or two-dimensional (2D) data (e.g., color 2D images, NIR images, etc.) of a dental site in a patient's oral cavity is also operatively connected to the computing device 1005. Scanner 1050 may include a probe (e.g., a hand held probe) for optically capturing three dimensional structures.

In some embodiments, the scanner 1050 includes an elongate wand including a probe at a distal end of the wand; a rigid structure disposed within a distal end of the probe; one or more structured light projectors coupled to the rigid structure (and optionally one or more non-structured light projectors coupled to the rigid structure, such as non-coherent light projectors and/or near-infrared light projectors); and one or more cameras coupled to the rigid structure. In some applications, each light projector may have an angular field of view (AFOI) of 45-120 degrees. Optionally, the one or more light projectors may utilize a laser diode light source, a light emitting diode (LED) light source, and/or other light source. Further, the structured light projector(s) may include a beam shaping optical element. Further still, the structured light projector(s) may include a pattern generating optical element.

The pattern generating optical element may be configured to generate a light pattern such as a distribution of discrete unconnected spots of light. The light pattern may be generated at all planes located between specific distances (e.g., 0-30 mm, 0-20 mm etc.) from the pattern generating optical element when the light source (e.g., laser diode) is activated to transmit light through the pattern generating optical element. In some applications, the pattern generating optical element utilizes diffraction and/or refraction to generate the distribution. Optionally, the pattern generating optical element has a light throughput efficiency of at least 90%.

For some applications, the light projectors and the cameras are positioned such that each light projector faces an object outside of the wand placed in its field of illumination. Optionally, each camera may face an object outside of the wand placed in its field of view. Additionally, or alternatively, one or more light projectors and/or cameras may face a mirror that reflects light to/from an object being scanned. Further, in some applications, at least 20% of the pattern features are in the field of view of at least one of the cameras.

The scanner 1050 may be used to perform intraoral scanning of a patient's oral cavity. A result of the intraoral scanning may be a sequence of intraoral scans and/or images that have been discretely generated (e.g., by pressing on a “generate scan” button of the scanner for each intraoral scan). Alternatively, a result of the intraoral scanning may be one or more videos of the patient's oral cavity. An operator may start recording the video with the scanner 1050 at a first position in the oral cavity, move the scanner 1050 within the oral cavity to a second position while the video is being taken, and then stop recording the video. In some embodiments, recording may start automatically as the scanner identifies that it has been positioned at a particular station (e.g., at a particular position and orientation in a patient's oral cavity). In either case, the scanner 1050 may transmit the discrete intraoral scans and/or images or intraoral video (referred to collectively as scan data 1035) to the computing device 1005. Note that in some embodiments the computing device may be integrated into the scanner 1050. Computing device 1005 may store the scan data 1035 in data store 1010. Alternatively, scanner 1050 may be connected to another system that stores the scan data in data store 1010. In such an embodiment, scanner 1050 may not be connected to computing device 1005.

Scanner 1050 may drive each one of one or more structured light projectors to project a light pattern (e.g., a distribution of discrete unconnected spots of light, a checkerboard pattern, etc.) on an intraoral three-dimensional surface and/or may drive one or more non-structured light projectors to project non-structured light onto the intraoral 3D surface. Scanner 1050 may further drive each one of one or more cameras to capture an image, the image including one or more image features corresponding to pattern features projected by one of the structured light projectors of the scanner 1050 if structured light was projected. Each one of the one or more cameras may include a camera sensor including an array of pixels. The images captured together at a particular time may together form an intraoral scan. The intraoral scans may be transmitted to computing device 1005 and/or stored in data store 1010 as scan data 1035.

Computing device 1005 may include an intraoral scanning module 1008 for facilitating intraoral scanning and generating 3D models of dental arches from intraoral scans. Intraoral scanning module 1008 may include an external illumination module 1015, a surface detection module 1018, and/or a model generation module 1025 in some embodiments. External illumination 1015 may analyze received image data 1035 to determine an amount of external illumination that is present during intraoral scanning. External illumination module 1015 may perform one or more actions responsive to detecting external illumination that satisfies one or more external illumination criteria. External illumination module 1015 may perform any of the aforementioned methods. In some embodiments, the external illumination module executes on a processing device internal to scanner 1050.

Surface detection module 1018 may analyze scan data 1035 to identify 3D points in captured scan data 1035 in embodiments. In some embodiments, surface detection module 1018 executes on a processing device internal to scanner 1050. Surface detection module 1018 may execute a correspondence algorithm on intraoral scans to determine the depths of spots or points in the intraoral scans. The surface detection module 1018 may access stored calibration data 1030 indicating (a) a camera ray of image feature corresponding to each pixel on the camera sensor of each one of the one or more cameras, and (b) a projector ray corresponding to each of the projected pattern features from each one of the one or more projectors, where each projector ray corresponds to a respective path of pixels on at least one of the camera sensors. Using the calibration data 1030 and the correspondence algorithm, surface detection module 1018 may, (1) for each projector ray i, identify for each detected image feature j on a camera sensor path corresponding to ray i, how many other cameras, on their respective camera sensor paths corresponding to ray i, detected respective image features k corresponding to respective camera rays that intersect ray i and the camera ray corresponding to detected image feature j. Ray i is identified as the specific projector ray that produced a detected image feature j for which the highest number of other cameras detected respective image features k. Surface detection module 1018 may further (2) compute a respective three-dimensional position on an intraoral three-dimensional surface at the intersection of projector ray i and the respective camera rays corresponding to the detected image feature j and the respective detected image features k. For some applications, running the correspondence algorithm further includes, following operation (1), removing from consideration projector ray i, and the respective camera rays corresponding to the detected image feature j and the respective detected image features k, and running the correspondence algorithm again for a next projector ray i.

Model generation module 1025 may perform surface registration between intraoral scans (e.g., may stitch together the intraoral scans as discussed above). Model generation module 1025 may then generate a virtual 3D model of a dental arch from the registered intraoral scans, as discussed above.

In some embodiments, intraoral scanning module 1008 includes a user interface module 1009 that provides a user interface that may display the generated virtual 3D model.

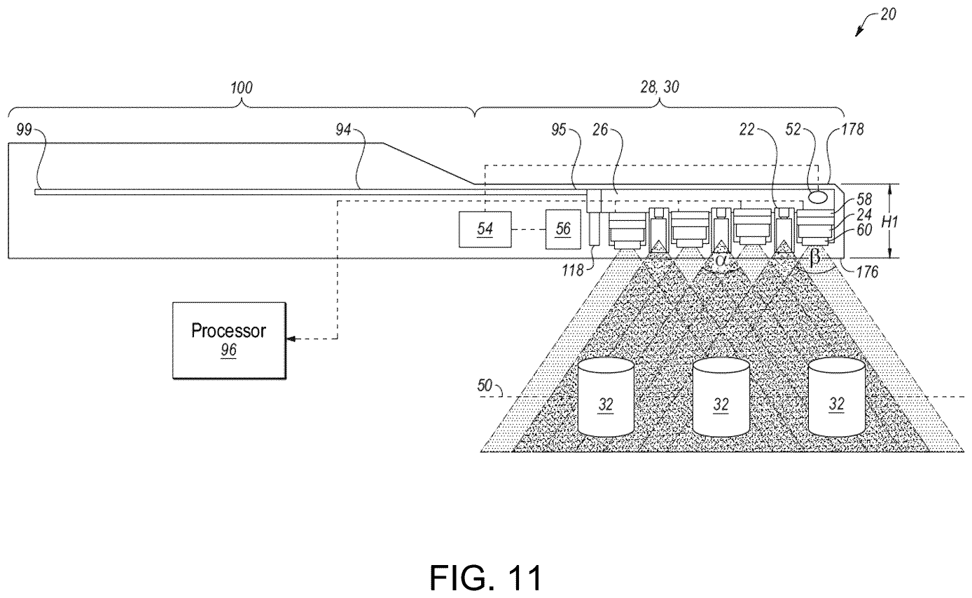

Reference is now made to FIG. 11, which is a schematic illustration of an elongate wand 20 for intraoral scanning, in accordance with some applications of the present disclosure. A plurality of light projectors 22 (e.g., including structured light projectors that project visible light, structured light projectors that project infrared light, and/or unstructured light projectors) and a plurality of cameras 24 are coupled to a rigid structure 26 disposed within a probe 28 at a distal end 30 of the wand. In some applications, during an intraoral scan, probe 28 enters the oral cavity of a subject.

In some particular applications of the present disclosure, an apparatus is provided for intraoral scanning (i.e., an intraoral scanner), the apparatus including an elongate wand with a probe at the distal end. During a scan, the probe may be configured to enter the intraoral cavity of a subject. Multiple light projectors (e.g., miniature structured light projectors and/or non-structured light projectors) as well multiple cameras (e.g., miniature cameras) may be coupled to a rigid structure disposed within a distal end of the probe. Each of the light projectors transmits light using a light source, such as a laser diode, light emitting diode (LED), etc. Each of the structured light projectors may be configured to project a pattern of light defined by a plurality of projector rays when the light source is activated. Each camera may be configured to capture a plurality of images that depict at least a portion of a dental object illuminated by the non-structured light and/or the structured light (e.g., a projected pattern of light as projected by the multiple structured light projectors). For structured light projectors, each of the structured light projectors may further include a pattern generating optical element. The pattern generating optical element may utilize diffraction and/or refraction to generate a light pattern (e.g., where coherent light is used). Alternatively, the pattern generating optical element may be a mask that blocks a portion of the light and passes a remainder of the light. The mask can be a static mask or a changing mask such as a digital micro-mirror (DMD), a display, etc. In some applications, the light pattern may be a distribution of discrete unconnected spots of light. In some applications, the light pattern may be a checkerboard pattern. Other light patterns such as grids, lines, regular distributions of polygons, etc. may additionally or alternatively be used. Optionally, the light pattern maintains the distribution of discrete unconnected spots or other pattern features at all planes located up to a threshold distance (e.g., 30 mm, 40 mm, 60 mm, etc.) from the pattern generating optical element, when the light source (e.g., laser diode) is activated to transmit light through the pattern generating optical element. Each of the cameras includes a camera sensor and objective optics including one or more lenses.

A light pattern includes a plurality of pattern features. Typically, a dense light pattern will have dense pattern features and a sparse light pattern will have sparse pattern features. However, in some embodiments a sparse pattern may have dense pattern features. The pattern features of a light pattern may include, for example, the corners of a checkerboard (e.g., for a checkerboard light pattern). In another example, pattern features may be discrete spots of light. When projecting a pattern comprising pattern features onto a surface of a 3D object, acquired images of the object will comprise a plurality of captured image features corresponding to the pattern features. A pattern feature and an image feature may be an individual well-defined location in the image feature or pattern feature. Examples of image features and pattern features include corners, edges, vertices, points, transitions, dots, stripes, and so on.

For some applications, light projectors 22 are positioned within probe 28 such that one or more light projector 22 faces a 3D surface 32A and/or a 3D surface 32B outside of wand 20 that is placed in its field of illumination, as opposed to positioning the light projectors in a proximal end of the wand and illuminating the 3D surface by reflection of light off a mirror and subsequently onto the 3D surface. Similarly, for some applications, cameras 24 are positioned within probe 28 such that each camera 24 faces a 3D surface 32A, 32B outside of wand 20 that is placed in its field of view, as opposed to positioning the cameras in a proximal end of the wand and viewing the 3D surface by reflection of light off a mirror and into the camera. This positioning of the projectors and the cameras within probe 28 enables the scanner to have an overall large field of view while maintaining a low profile probe.

In some applications, a height H1 of probe 28 is less than 15 mm, height H1 of probe 28 being measured from a lower surface 176 (sensing surface), through which reflected light from 3D surface 32A, 32B being scanned enters probe 28, to an upper surface 178 opposite lower surface 176. In some applications, the height H1 is between 10-15 mm.

In embodiments, the light projectors and cameras disposed at a distal end of an intraoral scanner are non-telecentric. A camera may have a predefined field of view (FOV) and/or a predefined angular field of view (AFOV). Similarly, a light projector may have a predefined field of illumination (FOI) and/or a predefined angular field of illumination (AFOI). The field of view (FOV) of a camera in the intraoral scanner may be understood as the extent of the observable world that is seen at any given moment by the camera. The FOV may be reported as an area measure, e.g. an area at a given distance from the camera or at a given distance below the probe of the intraoral scanner. The angular field of view (AFOV) is correlated to the FOV, and the AFOI is correlated to the FOI. However, herein the AFOV and AFOI are expressed as angles and the FOV and FOI are expressed as an area. In embodiments, the light projectors have an AFOI that cause the FOI of the light projectors to become larger with increased distance from the intraoral scanner. Additionally or alternatively, the cameras have an AFOV that cause the FOV of the cameras to become larger with increased distance/depth from the intraoral scanner. The AFOI of the light projectors may cause light patterns projected by the respective light projectors to have different amounts of interference and/or overlap at different depths. Depth as used in this context may refer to a distance between intraoral scanner (e.g., the light projector and/or camera of the intraoral scanner) and an imaged surface along an imaging axis that is orthogonal to a longitudinal axis of the intraoral scanner (e.g., to a longitudinal axis of a probe of the intraoral scanner that contains the cameras and light projectors).

Each camera may be configured to capture a plurality of images that depict at least a portion of the projected pattern(s) of light as projected by the multiple light projectors on an intraoral object. In some applications, the light projectors may have an AFOI of at least 45 degrees. Optionally, the AFOI may be less than 120 degrees. For structured light projectors, each of the structured light projectors (e.g., visible and/or infrared structured light projectors) may further include a pattern generating optical element. The pattern generating optical element may utilize diffraction and/or refraction to generate a light pattern (e.g., where coherent light is used). Alternatively, the pattern generating optical element may be a mask that blocks a portion of the light and passes a remainder of the light. The mask can be a static mask or a changing mask such as a digital micro-mirror (DMD), a display, etc. In some applications, one or more of the light pattern(s) may be a distribution of discrete unconnected spots of light. In some applications, at least one light pattern may be a checkerboard pattern. Other light patterns such as grids, lines, regular distributions of polygons, etc. may additionally or alternatively be used. Optionally, the light pattern maintains the distribution of discrete unconnected spots or other pattern features at all planes located up to a threshold distance (e.g., 30 mm, 40 mm, 60 mm, etc.) from the pattern generating optical element, when the light source (e.g., laser diode) is activated to transmit light through the pattern generating optical element. Each of the cameras includes a camera sensor and objective optics including one or more lenses.

In some applications, the AFOV of each of the cameras may be at least 45 degrees, e.g., at least 80 degrees, e.g., 85 degrees. Optionally, the AFOV of each of the cameras may be less than 120 degrees, e.g., less than 90 degrees. The fields of view of the various cameras may together form a field of view of the intraoral scanner. In any case, the fields of view and/or angular fields of view of the various cameras may be identical or non-identical. Similarly, the focal length of the various cameras may be identical or non-identical. Further, each camera may be configured to focus at an object focal plane that is located up to a threshold distance from the respective camera sensor (e.g., up to a distance of 10 mm, 20 mm, 30 mm, 40 mm, 50 mm, 60 mm, 70 mm, 80 mm, etc. from the respective camera sensor). As distances increase, the accuracy of the position of the detected surfaces decreases. In one embodiment, beyond the threshold distance the accuracy is below an accuracy threshold. Similarly, in some applications, the AFOI of each of the light projectors (e.g., structured light projectors and/or non-structured light projectors) may be at least 45 degrees and optionally less than 120 degrees. A large field of view (FOV) of the intraoral scanner achieved by combining the respective fields of view of all the cameras may improve accuracy (as compared to traditional scanners that typically have a FOV of 10-20 mm in the x-axis and γ-axis and a depth of capture of about 0-15 or 025 mm) due to reduced amount of image stitching errors, especially in edentulous regions, where the gum surface is smooth and there may be fewer clear high resolution 3-D features. Having a larger FOV for the intraoral scanner enables large smooth features, such as the overall curve of the tooth, to appear in each image frame, which improves the accuracy of stitching respective surfaces obtained from multiple such image frames.

In some applications, the total combined FOV of the various cameras (e.g., of the intraoral scanner) is between about 20 mm and about 50 mm along the longitudinal axis of the elongate wand, and about 20-60 mm (or 20-40 mm) in the z-axis, where the z-axis may correspond to depth. In further applications, the field of view may be about 20 mm, about 25 mm, about 30 mm, about 35 mm, or about 40 mm along the longitudinal axis and/or at least 20 mm, at least 25 mm, at least 30 mm, at least 35 mm, at least 40 mm, at least 45 mm, at least 50 mm, at least 55 mm, at least 60 mm, at least 65 mm, at least 70 mm, at least 75 mm, or at least 80 mm in the z-axis. In some embodiments, the combined field of view may change with depth (e.g., with scanning distance). For example, at a scanning distance of about 4 mm the field of view may be about 20 mm along the longitudinal axis, and at a scanning distance of about 20-50 mm the field of view may be about 30 mm or less along the longitudinal axis. If most of the motion of the intraoral scanner is done relative to the long axis (e.g., longitudinal axis) of the scanner, then overlap between scans can be substantial. In some applications, the field of view of the combined cameras is not continuous. For example, the intraoral scanner may have a first field of view separated from a second field of view by a fixed separation. The fixed separation may be, for example, along the longitudinal axis of the elongate wand.

In some embodiments, the large FOV of the intraoral scanner increases an accuracy of the detected depth of 3D surfaces. For example, the accuracy of a depth measurement of a detected 3D surface may be based on the longitudinal distance between two cameras or between a light projector and a camera, which may represent a triangulation baseline distance. In embodiments, cameras and/or light projectors may be spaced apart in a configuration that provides for increased accuracy of depth measurements for 3D surfaces that, for example, have a depth of up to 30 mm, up to 40 mm, 15-25 mm, and so on.

In some applications, cameras 24 each have a large AFOV β (beta) of at least 45 degrees, e.g., at least 70 degrees, e.g., at least 80 degrees, e.g., 85 degrees. In some applications, the field of view may be less than 120 degrees, e.g., less than 100 degrees, e.g., less than 90 degrees. In experiments performed by the inventors, AFOV β (beta) for each camera being between 80 and 90 degrees was found to be particularly useful because it provided a good balance among pixel size, field of view and camera overlap, optical quality, and cost. Cameras 24 may include a camera sensor 58 and objective optics 60 including one or more lenses. To enable close focus imaging cameras 24 may focus at an object focal plane 50 that is located between 1 mm and 30 mm, e.g., between 4 mm and 24 mm, e.g., between 5 mm and 11 mm, e.g., 9 mm-10 mm, from the lens that is farthest from the camera sensor. Cameras 24 may also detect 3D surfaces located at greater distances from the camera sensor, such as 3D surfaces at 40 mm, 50 mm, 60 mm, 70 mm, 80 mm, 90 mm, and so on from the camera sensor.

As described hereinabove, a large field of view achieved by combining the respective fields of view of all the cameras may improve accuracy due to reduced amount of image stitching errors, especially in edentulous regions, where the gum surface is smooth and there may be fewer clear high resolution 3-D features. Having a larger field of view enables large smooth features, such as the overall curve of the tooth, to appear in each image frame, which improves the accuracy of stitching respective surfaces obtained from multiple such image frames.

Similarly, light projectors 22 may each have a large AFOI a (alpha) of at least 45 degrees, e.g., at least 70 degrees. In some applications, AFOI a (alpha) may be less than 120 degrees, e.g., than 100 degrees.

For some applications, in order to improve image capture, each camera 24 has a plurality of discrete preset focus positions, in each focus position the camera focusing at a respective object focal plane 50. Each of cameras 24 may include an autofocus actuator that selects a focus position from the discrete preset focus positions in order to improve a given image capture. Additionally or alternatively, each camera 24 includes an optical aperture phase mask that extends a depth of focus of the camera, such that images formed by each camera are maintained focused over all 3D surface distances located between 1 mm and 30 mm, e.g., between 4 mm and 24 mm, e.g., between 5 mm and 11 mm, e.g., 9 mm-10 mm, from the lens that is farthest from the camera sensor. In further embodiments, images formed by one or more cameras may additionally be maintained focused over greater 3D surface distances, such as distances up to 40 mm, up to 50 mm, up to 60 mm, up to 70 mm, up to 80 mm, or up to 90 mm.

In some applications, light projectors 22 and cameras 24 are coupled to rigid structure 26 in a closely packed and/or alternating fashion, such that (a) a substantial part of each camera's field of view overlaps the field of view of neighboring cameras, and (b) a substantial part of each camera's field of view overlaps the field of illumination of neighboring projectors. Optionally, at least 20%, e.g., at least 50%, e.g., at least 75% of the projected pattern of light are in the field of view of at least one of the cameras at an object focal plane 50 that is located at least 4 mm from the lens that is farthest from the camera sensor. Due to different possible configurations of the projectors and cameras, some of the projected pattern may never be seen in the field of view of any of the cameras, and some of the projected pattern may be blocked from view by 3D surface 32A, 32B as the scanner is moved around during a scan.

Rigid structure 26 may be a non-flexible structure to which light projectors 22 and cameras 24 are coupled so as to provide structural stability to the optics within probe 28. Coupling all the projectors and all the cameras to a common rigid structure helps maintain geometric integrity of the optics of each light projector 22 and each camera 24 under varying ambient conditions, e.g., under mechanical stress as may be induced by the subject's mouth. Additionally, rigid structure 26 helps maintain stable structural integrity and positioning of light projectors 22 and cameras 24 with respect to each other. As further described hereinbelow, controlling the temperature of rigid structure 26 may help enable maintaining geometrical integrity of the optics through a large range of ambient temperatures as probe 28 enters and exits a subject's oral cavity or as the subject breathes during a scan.

As shown, 3D surface 32A and 3D surface 32B are in a FOV of the probe 28, with 3D surface 32A being relatively close to the probe 28 and 3D surface 32B being relatively far from the probe 28.

Whether a pair of cameras or a pair of a camera and a light projector are used, the accuracy of the triangulation used to determine the depth of 3D surfaces may be roughly estimated by the following equation:

$${z}_{err} = \frac{{p}_{err} \cdot {z}^{2}}{f \cdot b}$$

Where zₑᵣᵣ is the error in the depth, pₑᵣᵣ is the basic image processing error (generally a sub-pixel error), z is the depth, f is the focal length of the lens, and b is the base line (the distance between two cameras when using stereo imaging or the distance between the camera and the light projector when using structured light). In embodiments, the probe of the intraoral scanner is configured such that the maximum baseline between two cameras or between a camera and a light projector is large and provides a high level of accuracy for triangulation.

In some embodiments, wand 20 corresponds to the intraoral scanner of U.S. Pat. No. 11,896,461, issued Feb. 13, 2024, which is incorporated by reference herein.

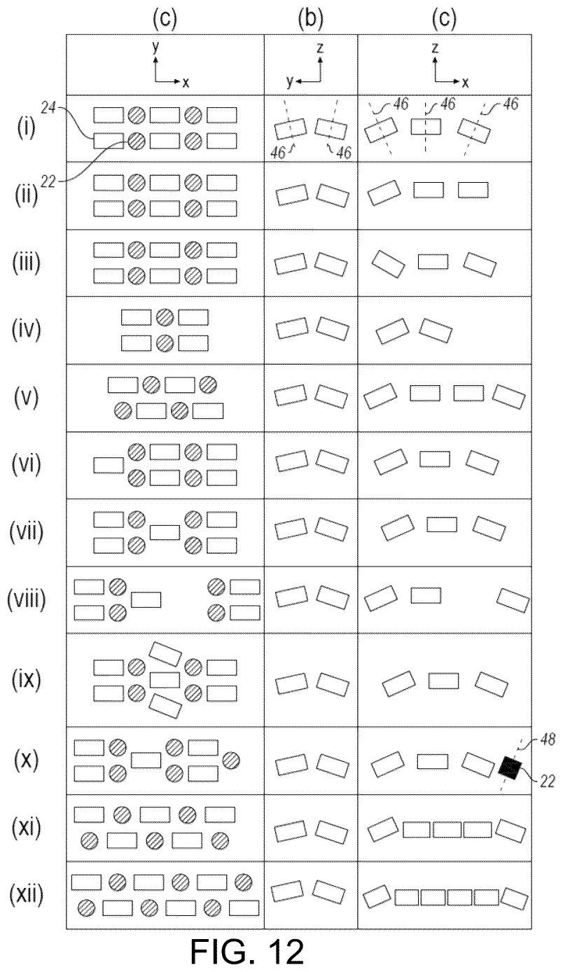

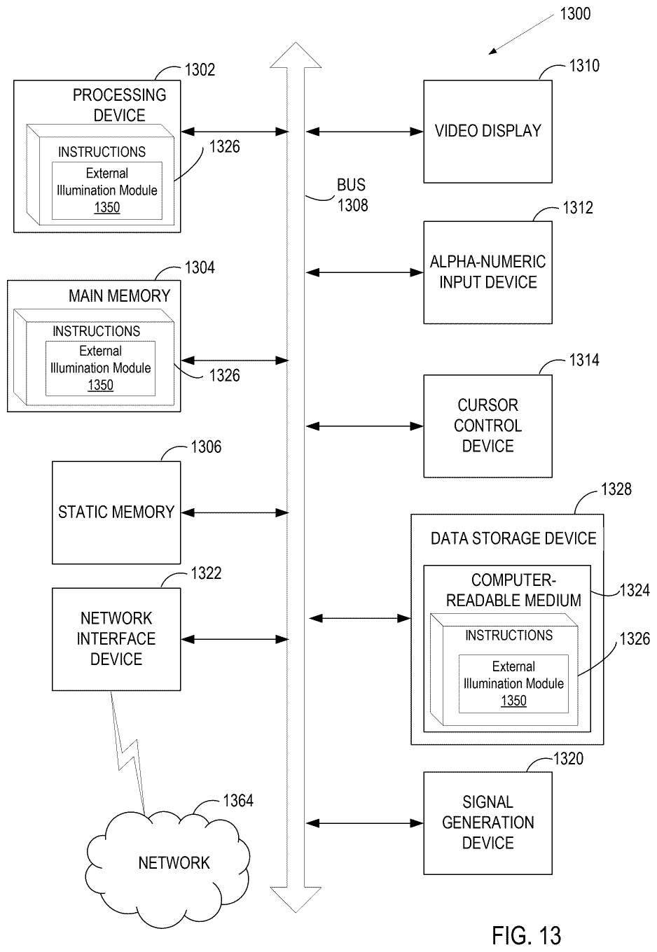

Reference is now made to FIG. 12, which is a chart depicting a plurality of different configurations for the position of light projectors 22 and cameras 24 in probe 28, in accordance with some applications of the present disclosure. Light projectors 22 are represented in FIG. 12 by circles and cameras 24 are represented in FIG. 12 by rectangles. Light projectors may be infrared light projectors, visible light projectors, or a combination thereof. It is noted that rectangles are used to represent the cameras, since typically, each camera sensor 58 and the AFOV β (beta) of each camera 24 have aspect ratios of 1:2. Column (a) of FIG. 12 shows a bird's eye view of the various configurations of light projectors 22 and cameras 24. The x-axis as labeled in the first row of column (a) corresponds to a central longitudinal axis of probe 28. Column (b) shows a side view of cameras 24 from the various configurations as viewed from a line of sight that is coaxial with the central longitudinal axis of probe 28. Column (b) of FIG. 12 shows cameras 24 positioned so as to have optical axes 46 at an angle of 90 degrees or less, e.g., 35 degrees or less, with respect to each other. Column (c) shows a side view of cameras 24 of the various configurations as viewed from a line of sight that is perpendicular to the central longitudinal axis of probe 28.

In one embodiment, the distal-most (toward the positive x-direction in FIG. 12) and proximal-most (toward the negative x-direction in FIG. 12) cameras 24 are positioned such that their optical axes 46 are slightly turned inwards, e.g., at an angle of 90 degrees or less, e.g., 35 degrees or less, with respect to the next closest camera 24. The camera(s) 24 that are more centrally positioned, i.e., not the distal-most camera 24 nor proximal-most camera 24, are positioned so as to face directly out of the probe, their optical axes 46 being substantially perpendicular to the central longitudinal axis of probe 28. It is noted that in row (xi) a projector 22 is positioned in the distal-most position of probe 28, and as such the optical axis 48 of that projector 22 points inwards, allowing a larger number of spots 33 projected from that particular projector 22 to be seen by more cameras 24.

In one embodiment, the number of light projectors 22 in probe 28 may range from two, e.g., as shown in row (iv) of FIG. 12, to six, e.g., as shown in row (xii). In one embodiment, the number of cameras 24 in probe 28 may range from four, e.g., as shown in rows (iv) and (v), to seven, e.g., as shown in row (ix) or eight. It is noted that the various configurations shown in FIG. 12 are by way of example and not limitation, and that the scope of the present disclosure includes additional configurations not shown. For example, the scope of the present disclosure includes more than five projectors 22 positioned in probe 28 and more than seven cameras positioned in probe 28.

In an example application, an apparatus for intraoral scanning (e.g., an intraoral scanner) includes an elongate wand comprising a probe at a distal end of the elongate wand, at least two light projectors disposed within the probe, and at least four cameras disposed within the probe. Each light projector may include at least one light source configured to generate light when activated, and a pattern generating optical element that is configured to generate a pattern of light when the light is transmitted through the pattern generating optical element. Each of the at least four cameras may include a camera sensor and one or more lenses, wherein each of the at least four cameras is configured to capture a plurality of images that depict at least a portion of the projected pattern of light on an intraoral surface. In one embodiment, a majority of the at least two light projectors and the at least four cameras may be arranged in at least two rows that are each approximately parallel to a longitudinal axis of the probe, the at least two rows comprising at least a first row and a second row.

In a further application, a distal-most camera along the longitudinal axis and a proximal-most camera along the longitudinal axis of the at least four cameras are positioned such that their optical axes are at an angle of 90 degrees or less with respect to each other from a line of sight that is perpendicular to the longitudinal axis. Cameras in the first row and cameras in the second row may be positioned such that optical axes of the cameras in the first row are at an angle of 90 degrees or less with respect to optical axes of the cameras in the second row from a line of sight that is coaxial with the longitudinal axis of the probe. A remainder of the at least four cameras other than the distal-most camera and the proximal-most camera have optical axes that are substantially parallel to the longitudinal axis of the probe. Each of the at least two rows may include an alternating sequence of light projectors and cameras.

In a further application, the at least four cameras comprise at least five cameras, the at least two light projectors comprise at least five light projectors, a proximal-most component in the first row is a light projector, and a proximal-most component in the second row is a camera.

In a further application, the distal-most camera along the longitudinal axis and the proximal-most camera along the longitudinal axis are positioned such that their optical axes are at an angle of 35 degrees or less with respect to each other from the line of sight that is perpendicular to the longitudinal axis. The cameras in the first row and the cameras in the second row may be positioned such that the optical axes of the cameras in the first row are at an angle of 35 degrees or less with respect to the optical axes of the cameras in the second row from the line of sight that is coaxial with the longitudinal axis of the probe.

In a further application, the at least four cameras may have a combined field of view of about 25-45 mm or about 20-50 mm along the longitudinal axis and a field of view of about 20-40 mm or about 15-80 mm along a z-axis corresponding to distance from the probe. Other FOVs discussed herein may also be provided.

In the examples shown in FIGS. 1 and 11-12, cameras and structured light projectors directly face an object that is scanned. However, in other embodiments one or more structured light projectors and/or cameras may face a mirror, which may redirect light rays and returning light rays towards and/or from an object being scanned. In some embodiments, structured light projectors and cameras are arranged into one or more scan units, which may be arranged along the longitudinal axis of the probe. A scan unit may be understood herein as a unit comprising at least light projector and one or more cameras. In some embodiments, each scan unit comprises at least two cameras having at least partly overlapping fields of view along different camera optical axes. In one embodiment, each scan unit comprises at least four cameras having at least partly overlapping fields of view along different camera optical axes. An advantage of having overlapping fields of view of the cameras is an improved accuracy due to a reduced amount of image stitching errors. A further advantage of utilizing multiple cameras, such as two or more cameras, is that the reliability of the determination of 3D points is improved, whereby the accuracy of the generated digital 3D representation is improved. A scan unit may further comprise one or more lenses such as collimation lenses or projection lenses.

In some embodiments, one or more scan units may face an object being scanned and/or one or more scan units may face a mirror. Scan units that face an object being scanned may be referred to as downward looking scan units, and may have an imaging axis that is at an angle (e.g., perpendicular) to a longitudinal axis of a probe. Scan units that face a mirror may be referred to as forward looking scan units, and may have an imaging axis that is approximately parallel to a longitudinal axis of a probe. In some embodiments, all scan units are downward looking. In some embodiments, all scan units are forward looking. In some embodiments, some scan units are downward looking and some scan units are forward looking. In some embodiments, scan units are used as set forth in U.S. Patent Application No. 63/656,524, filed Jun. 5, 2024, which is incorporated by reference herein in its entirety.

In some embodiments, the intraoral scanner comprises a plurality of scan units positioned along the longitudinal axis of the intraoral scanner. For example, two scan units may be positioned in series along the longitudinal axis of the intraoral scanner. A scan unit may have a predefined field of view (FOV) and/or a predefined angular field of view (AFOV). In some embodiments, the FOV of each scan unit is at least 300 mm², preferably at least 400 mm², preferably at least 500 mm², preferably at least 550 mm², wherein the area is measured for a given predefined focus distance or working distance. As an example, the field of view of the intraoral scanner may be at least 20×20 mm², such as at least 23×23 mm², at a working distance of between 18 mm to 36 mm, such as approximately 20 mm to 24 mm. For some applications, e.g. for dental scanning applications, the intraoral scanner has a working distance of between 10 mm and 100 mm. In some embodiments, a working distance of the projector unit of between 10 mm and 70 mm, such as between 15 mm and 50 mm, is used. Since the scan unit(s) then take up less space inside the intraoral scanner, it also allows for multiple scan units to be placed in succession inside the intraoral scanner. In some embodiments, the intraoral scanner is able to project a pattern in focus at the exit of the tip of the intraoral scanner, e.g. at the optical window of the s intraoral scanner or at an opening in the surface of the intraoral scanner. The working distance may be understood as the object to lens distance where the image is at its sharpest focus. The working distance may also, or alternatively, be understood as the distance from the object to a front lens, e.g. a front lens of the projector unit. The front lens may be the one or more focus lenses of the projector unit.

In some embodiments the elongated probe comprises one or more openings and/or one or more optical windows at a distal end of the elongated probe. In some embodiments, there is an opening and/or an optical window in the elongated probe, wherein the opening/window is associated with each scan unit, such that each scan unit is configured to project the light pattern through said opening or optical window. Accordingly, the elongated probe may comprise an opening and/or an optical window for each scan unit of the intraoral scanner. The optical window may be made in a polymer material such as poly(methyl methacrylate) (PMMA) or in a ceramic or glass material such as Sapphire glass. The optical window may be made in a transparent, crystalline, ceramic material, such as aluminum oxide (Al₂O₃). Alternatively, the optical window may be made of a mineral glass. In some embodiments, the predefined distance mentioned in relation to the FOV of a given scan unit is measured below said opening/window. In some embodiments, the FOV of at least one scan unit is at least 500 mm², such as approximately 23×23 mm², in a distance approximately 0-15 mm, such as 4-7 mm below said opening/window. This may correspond to a working distance of between 15 mm and 50 mm, such as between 15 mm and 36 mm.

The angular field of view (AFOV) of a scan unit may be correlated to the FOV. In accordance with some embodiments, each scan unit defines an angular field of view (AFOV) of between 50° to 80°, such as between 60° to 75°. In accordance with some embodiments, the projector optical axis and the camera optical axis of at least one camera define a camera-projector angle of approximately 5 to 25 degrees, or 5 to 15 degrees, or 5 to 10 degrees, or 8 to 10 degrees. In some embodiments, the scan unit(s) are rotationally symmetric, such that each camera optical axis defines an approximately similar camera-projector angle with the projector unit of the scan unit.

In embodiments, wherein the intraoral scanner comprises at least two scan units, the intraoral scanner has a FOV, which is larger than the FOV of each scan unit. As an example, if the intraoral scanner comprises two scan units, each scan unit having a predefined FOV, then the intraoral scanner will have twice as large a FOV as each scan unit, provided there is no overlap in FOV between the scan units. In some cases, there may be a small overlap in FOV, but in general the intraoral scanner will have a larger field of view, or in other words an extended field of view, compared to one scan unit in isolation. Accordingly, the FOV of the intraoral scanner can be increased/scaled by the number of scan units in the intraoral scanner. In some embodiments, the intraoral scanner comprises at least three scan units. Accordingly, the intraoral scanner may further comprise a third scan unit comprising a third projector unit, said projector unit preferably configured to project the light pattern at a predefined third focus distance. A scan unit may further comprise at least one reflecting element, such as a mirror or a prism, wherein said reflecting element is configured to alter the direction of the light projected by the projector unit of the scan unit. In general, a scan unit can be oriented in many different ways, wherein the orientation is defined according to the projector optical axis of the scan unit. As an example, a scan unit may be oriented such that the projector optical axis of the scan unit is substantially parallel with the longitudinal axis of the intraoral scanner. Additionally, a scan unit may be oriented such that the light from the projector unit is projected in a forward direction, i.e. towards the distal end of the intraoral scanner. In case, a scan unit is oriented in this way, the scan unit is also referred to as being in a forward-looking configuration. In some embodiments, each scan unit comprises a reflecting element. In other embodiments, at least one scan unit comprises a reflecting element.

As another example, a scan unit may be oriented such that the projector optical axis of the scan unit is angled with respect to the longitudinal axis of the intraoral scanner or with respect to a projector optical axis of another scan unit. In some embodiments, at least one of the projector optical axes is substantially orthogonal to the longitudinal axis of the intraoral scanner. Additionally, such a scan unit may be oriented such that the light from the projector unit is projected in a downward direction, i.e. directly towards the dental object to be scanned. In case a scan unit is oriented in this way, the scan unit is also referred to as being in a downward-looking configuration. If the intraoral scanner comprises a plurality of scan units, such as at least two scan units, the scan units may be in different configurations, e.g. a first scan unit in the forward-looking configuration and a second scan unit in the downward-looking configuration. In this embodiment, the first projector optical axis is substantially parallel to the longitudinal axis of the intraoral scanner, and the second projector optical axis is substantially orthogonal to the longitudinal axis of the intraoral scanner. In other words, a first projector optical axis of a first projector unit of the first scan unit is angled with respect to a second projector optical axis of a second projector unit of the second scan unit. This angle may be at least 45°, such as at least 75°, or at least 85°, or approximately 90°.

FIG. 12 illustrates a diagrammatic representation of a machine in the example form of a computing device 1200 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computing device 1200 includes a processing device 1202, a main memory 1204 (e.g., read-only memory (ROM), flash memory, dynamic random access memory (DRAM) such as synchronous DRAM (SDRAM), etc.), a static memory 1206 (e.g., flash memory, static random access memory (SRAM), etc.), and a secondary memory (e.g., a data storage device 1228), which communicate with each other via a bus 1208.

Processing device 1202 represents one or more general-purpose processors such as a microprocessor, central processing unit, or the like. More particularly, the processing device 1202 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1202 may also be one or more special-purpose processing devices such as an application specific integrated circuit (ASIC), a field programmable gate array (FPGA), a digital signal processor (DSP), network processor, or the like. Processing device 1202 is configured to execute the processing logic (instructions 1226) for performing operations and operations discussed herein.

The computing device 1200 may further include a network interface device 1222 for communicating with a network 1264. The computing device 1200 also may include a video display unit 1210 (e.g., a liquid crystal display (LCD) or a cathode ray tube (CRT), an alphanumeric input device 1212 (e.g., a keyboard), a cursor control device 1214 (e.g., a mouse), and a signal generation device 1220 (e.g., a speaker).

The data storage device 1228 may include a machine-readable storage medium (or more specifically a non-transitory computer-readable storage medium) 1224 on which is stored one or more sets of instructions 1226 embodying any one or more of the methodologies or functions described herein. Wherein a non-transitory storage medium refers to a storage medium other than a carrier wave. The instructions 1226 may also reside, completely or at least partially, within the main memory 1204 and/or within the processing device 1202 during execution thereof by the computer device 1200, the main memory 1204 and the processing device 1202 also constituting computer-readable storage media.

The computer-readable storage medium 1224 may also be used to store an intraoral scanning module 1250, which may correspond to similarly named components of FIG. 10. The computer readable storage medium 1224 may also store a software library containing methods that call an intraoral scanning module 1250, a scan registration module and/or a model generation module. While the computer-readable storage medium 1224 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

Multiple possible implementations of the disclosure are provided below.

Implementation 1. A method of intraoral imaging, comprising: projecting first light having a known first intensity onto a dental object; capturing one or more first images of the dental object illuminated by the first light; determining a captured first intensity of the one or more first images; estimating an amount of external illumination based at least in part on the known first intensity and the captured first intensity; and performing an action based on the estimated amount of external illumination.

Implementation 2. The method of implementation 1, wherein the first light is structured coherent light.

Implementation 3. The method of implementation 2, wherein the first light has the known first intensity at one or more first wavelengths, wherein the captured first intensity is at one or more second wavelengths, and wherein the one or more second wavelengths include a wavelength not included in the one or more first wavelengths.

Implementation 4. The method of implementation 3, wherein the one or more first wavelengths comprise a green light wavelength and a blue light wavelength, and wherein the one or more second wavelengths comprise a red light wavelength.

Implementation 5. The method of implementation 3 or 4, further comprising: determining that the captured first intensity for the wavelength not included in the one or more first wavelengths exceeds a threshold; and outputting a warning about excessive external illumination.

Implementation 6. The method of implementation 1, wherein performing the action comprises outputting a notice associated with the estimated amount of external illumination.

Implementation 7. The method of implementation 6, wherein the notice comprises a visual notice output to a display of at least one of a computing device or an intraoral scanner.

Implementation 8. The method of implementation 6 or 7, wherein the notice comprises an audio notice output to a speaker of at least one of a computing device or an intraoral scanner.

Implementation 9. The method of implementation 1, wherein the first light is structured white light.

Implementation 10. The method of implementation 9, wherein the structured white light comprises a checkerboard pattern.

Implementation 11. The method of implementation 1, wherein the first light is non-structured white light or infrared light.

Implementation 12. The method of implementations 1-11, wherein the one or more first images comprise a plurality of frames captured by a camera of an intraoral scanner, the method further comprising: determining, for each frame of the plurality of frames, whether the amount of external illumination for the frame exceeds a first threshold; and determining whether a number of frames for which the amount of external illumination exceeds the first threshold exceeds a second threshold.

Implementation 13. The method of implementations 1-12, wherein the one or more first images comprise a plurality of images each captured by a different camera of an intraoral scanner, the method further comprising: determining, for each image of the plurality of images, whether the amount of external illumination for the image exceeds a first threshold; and determining whether a number of images for which the amount of external illumination exceeds the first threshold exceeds a second threshold.

Implementation 14. The method of implementations 1-13, further comprising: projecting second light having a known second intensity onto the dental object, wherein there is a known first difference between the second intensity and the first intensity; capturing one or more second images of the dental object illuminated by the second light; determining a captured second intensity of the one or more second images; and determining a second difference between the captured second intensity and the captured first intensity; wherein the amount of external illumination is estimated based on a ratio of the first difference to the second difference.

Implementation 15. The method of implementation 14, further comprising: outputting the one or more first images to a display; determining first average values of one or more color channels for the one or more first images; determining second average values of the one or more color channels for the one or more second images; adjusting gains of the one or more color channels for the one or more second images based on a difference between the second average values and the first average values of the one or more color channels; and outputting the one or more second images to the display using the adjusted gains for the one or more color channels.

Implementation 16. The method of implementations 1-15, further comprising: projecting second light having a known second intensity onto the dental object, wherein there is a known first difference between the second intensity and the first intensity; capturing one or more second images of the dental object illuminated by the second light; determining a captured second intensity of the one or more second images; again projecting the first light having the known first intensity onto the dental object; capturing one or more third images of the dental object illuminated by the first light; determining a captured third intensity of the one or more third images; determining an average of the captured first intensity and the captured third intensity; and determining a second difference between the captured second intensity and the average of the captured first intensity and the captured third intensity; wherein the amount of external illumination is estimated based on a ratio of the first difference to the second difference.

Implementation 17. The method of implementations 1-16, further comprising: alternately projecting the first light having the known first intensity and second light having a known second intensity onto the dental object, wherein there is a known first difference between the second intensity and the first intensity; alternately capturing the one or more first images of the dental object illuminated by the first light and one or more second images of the dental object illuminated by the second light; determining captured intensities for each of the one or more first images and the one or more second images; determining a first average of the captured intensities of the one or more first images in a moving window; determining a second average of the captured intensities of the one or more second images in the moving window; and determining a second difference between the second average and the first average; wherein the amount of external illumination is estimated based on a ratio of the first difference to the second difference.

Implementation 18. The method of implementations 1-17, wherein performing the action comprises outputting a warning of excess external illumination, the method further comprising: determining that the warning of excess external illumination has been output for a threshold amount of time; and adjusting or stopping the warning of excess external illumination.

Implementation 19. The method of implementations 1-18, further comprising: determining that the amount of external illumination exceeds a threshold; wherein performing the action comprises increasing an intensity of the first light.

Implementation 20. The method of implementation 19, further comprising: reducing a gain of one or more cameras that capture the one or more first images.

Implementation 21. The method of implementation 19 or 20, further comprising: increasing a frame rate of one or more cameras that capture the one or more first images from a first frame rate to a second frame rate.

Implementation 22. The method of implementation 21, further comprising: introducing one or more dummy frames responsive to increasing the frame rate, wherein the one or more dummy frames are not used to generate images, and wherein a number of frames in the first frame rate and the second frame rate that are used to generate images is the same.

Implementation 23. The method of implementations 1-19, wherein the first light has the known first intensity at one or more first wavelengths, and wherein the captured first intensity is at one or more second wavelengths, the method further comprising: capturing one or more second images of the dental object while one or more light projectors that projected the first light are off; determining a captured second intensity of the one or more second images at the one or more second wavelengths; and determining a difference between the captured second intensity and the captured first intensity, wherein the difference indicates the amount of external illumination.

Implementation 24. A method of intraoral scanning, comprising: projecting first light having a known first intensity onto a dental object; capturing one or more first images of the dental object illuminated by the first light; determining a captured first intensity of the one or more first images; projecting second light having a known second intensity onto the dental object, wherein there is a known first difference between the second intensity and the first intensity; capturing one or more second images of the dental object illuminated by the second light; determining a captured second intensity of the one or more second images; estimating an amount of external illumination based at least in part on the known first intensity, the known second intensity, the captured first intensity and the captured second intensity; and compensating for the estimated amount of external illumination.

Implementation 25. The method of implementation 24, wherein the first light is structured light comprising at least one of a first wavelength or a second wavelength.

Implementation 26. The method of implementation 24 or 25, wherein the first light is non-structured light white light.

Implementation 27. The method of implementations 24-26, wherein the first light is structured white light.

Implementation 28. The method of implementations 24-27, wherein the first light is non-structured light having a first wavelength.

Implementation 29. The method of implementations 24-28, wherein determining the amount of external illumination comprises: determining a second difference between the captured second intensity and the captured first intensity; and determining a ratio of the first difference to the second difference.

Implementation 30. The method of implementations 24-29, wherein: determining the captured first intensity for each image of the one or more first images comprises, for each pixel or group of pixels of the image, determining an intensity value for each color channel; and determining the captured second intensity for each of the one or more second images comprises, for each pixel or group of pixels of the image, determining an intensity value for each color channel; and compensating for the estimated amount of external illumination comprises determining different adjustments to each color channel of each pixel or group of pixels in the one or more first images and/or in the one or more second images.

Implementation 31. The method of implementations 24-30, further comprising: outputting the one or more first images to a display; determining first average values of one or more color channels for the one or more first images; determining second average values of the one or more color channels for the one or more second images; adjusting gains of the one or more color channels for the one or more second images based on a difference between the second average values and the first average values of the one or more color channels; and outputting the one or more second images to the display using the adjusted gains for the one or more color channels.

Implementation 32. The method of implementations 24-31, wherein the second intensity is 70-90% of the first intensity.

Implementation 33. The method of implementations 24-32, further comprising: alternately projecting the first light having the known first intensity and second light having the known second intensity; alternately capturing the one or more first images of the dental object illuminated by the first light and one or more second images of the dental object illuminated by the second light; determining captured intensities for each of the one or more first images and the one or more second images; determining a first average of the captured intensities of the one or more first images in a moving window; determining a second average of the captured intensities of the one or more second images in the moving window; and determining a second difference between the second average and the first average; wherein the amount of external illumination is estimated based on a ratio of the first difference to the second difference.

Implementation 34. The method of implementations 24-33, further comprising: outputting a warning responsive to determining that the amount of external illumination exceeds a threshold.

Implementation 35. The method of implementations 24-34, further comprising: increasing an intensity of at least one of the first light or the second light responsive to determining that the amount of external illumination exceeds a threshold.

Implementation 36. The method of implementation 35, further comprising: reducing a gain of one or more cameras that capture at least one of the one or more first images or the one or more second images responsive to increasing the intensity of at least one of the first light or the second light.

Implementation 37. The method of implementations 24-36, further comprising: increasing a frame rate of one or more cameras that capture the one or more first images and the one or more second images from a first frame rate to a second frame rate responsive to determining that the amount of external illumination exceeds a threshold.

Implementation 38. The method of implementation 37, further comprising: introducing one or more dummy frames responsive to increasing the frame rate, wherein the one or more dummy frames are not used to generate images, and a number of frames in the first frame rate and the second frame rate that are used to generate images is the same.

Implementation 39. A method of intraoral imaging, comprising: capturing one or more images of a dental object illuminated by light having one or more first wavelengths; determining a captured intensity of the one or more images at a second wavelength that is not included in the one or more first wavelengths; estimating an amount of external illumination based on the captured intensity of the one or more images at the second wavelength; and performing an action based on the estimated amount of external illumination.

Implementation 40. The method of implementation 39, wherein the light is structured coherent light.

Implementation 41. The method of implementation 40, wherein the one or more first wavelengths comprise a green light wavelength and a blue light wavelength, and wherein the second wavelength comprises a red light wavelength.

Implementation 42. The method of implementation 40 or 41, further comprising: determining that the captured intensity of the one or more images at the second wavelength exceeds a threshold; and outputting a warning about excessive external illumination.

Implementation 43. The method of implementations 39-42, wherein the one or more images comprise a plurality of frames captured by a camera of an intraoral scanner, the method further comprising: determining, for each frame of the plurality of frames, whether the amount of external illumination for the frame exceeds a first threshold; and determining whether a number of frames for which the amount of external illumination exceeds the first threshold exceeds a second threshold.

Implementation 44. The method of implementations 39-43, wherein the one or more images comprise a plurality of images each captured by a different camera of an intraoral scanner, the method further comprising: determining, for each image of the plurality of images, whether the amount of external illumination for the image exceeds a first threshold; and determining whether a number of images for which the amount of external illumination exceeds the first threshold exceeds a second threshold.

Implementation 45. An intraoral scanning system configured to perform the method of any of implementations 1-44, the intraoral scanning system comprising: an intraoral scanner, comprising one or more light projectors and one or more cameras; and a computing device.

Implementation 46. An intraoral scanner configured to perform the method of any of implementations 1-44, the intraoral scanner comprising: one or more light projectors; one or more cameras; and one or more processing devices.

Implementation 47. An intraoral scanning system, comprising: an intraoral scanner comprising: one or more structured light projectors configured to project structured light comprising a light pattern; one or more non-structured light projectors configured to project non-structured light; and one or more cameras configured to capture intraoral scan data comprising one or more images of a dental object illuminated by at least one of the one or more structured light projectors or the one or more non-structured light projectors; and a computing device configured to: estimate an amount of external illumination based at least in part on a) a known first intensity at which at least one of the one or more structured light projectors projected the structured light or the one or more non-structured light projectors projected the non-structured light and b) a captured intensity in the one or images of the dental object for one or more color channels; and perform an action based on the estimated amount of external illumination.

Implementation 48. The intraoral scanning system of implementation 47, further comprising: a polarization filter on the one or more cameras that matches a polarization of at least one of the structured light or the non-structured light.

Implementation 49. The intraoral scanning system of implementation 47 or 48, wherein the one or more cameras comprise global shutters.

Implementation 50. The intraoral scanning system of implementations 47-49, wherein the one or more cameras comprise one or more narrow band color filters matched to wavelengths output by at least one of the one or more structured light projectors or the one or more non-structured light projectors.

Implementation 51. The intraoral scanning system of implementations 47-50, further comprising: a light blocking device attached to a probe of the intraoral scanner, wherein the light blocking device blocks at least a portion of the external illumination from entering an oral cavity during intraoral scanning.

Implementation 52. The intraoral scanning system of implementation 51, wherein the light blocking device is removable from the intraoral scanner.

Implementation 53. The intraoral scanning system of implementations 47-52, further comprising: a dark filter on the one or more cameras.

Implementation 54. The intraoral scanning system of implementations 47-53, wherein performing the action comprises outputting warning of excessive external illumination.

Implementation 55. The intraoral scanning system of implementations 47-54, wherein performing the action comprises compensating for the external illumination.

Implementation 56. An intraoral scanner, comprising: one or more structured light projectors configured to project structured light comprising a light pattern; one or more non-structured light projectors configured to project non-structured light; one or more cameras configured to capture intraoral scan data comprising one or more images of a dental object illuminated by at least one of the one or more structured light projectors or the one or more non-structured light projectors; and one or more processing device configured to: estimate an amount of external illumination based at least in part on a) a known first intensity at which at least one of the one or more structured light projectors projected the structured light or the one or more non-structured light projectors projected the non-structured light and b) a captured intensity in the one or images of the dental object for one or more color channels; and perform an action based on the estimated amount of external illumination.

Implementation 57. The intraoral scanner of implementation 56, further comprising: a polarization filter on the one or more cameras that matches a polarization of at least one of the structured light or the non-structured light.

Implementation 58. The intraoral scanner of implementation 56 or 57, wherein the one or more cameras comprise global shutters.

Implementation 59. The intraoral scanner of implementations 56-58, wherein the one or more cameras comprise one or more narrow band color filters matched to wavelengths output by at least one of the one or more structured light projectors or the one or more non-structured light projectors.

Implementation 60. The intraoral scanner of implementations 56-59, further comprising: a light blocking device attached to a probe of the intraoral scanner, wherein the light blocking device blocks at least a portion of the external illumination from entering an oral cavity during intraoral scanning.

Implementation 61. The intraoral scanner of implementation 60, wherein the light blocking device is removable from the intraoral scanner.

Implementation 62. The intraoral scanner of implementations 56-61, further comprising: a dark filter on the one or more cameras.

Implementation 63. The intraoral scanning system of implementations 56-62, wherein performing the action comprises outputting warning of excessive external illumination.

Implementation 64. The intraoral scanning system of implementations 56-63, wherein performing the action comprises compensating for the external illumination.

It is to be understood that the above description is intended to be illustrative, and not restrictive. Many other embodiments will be apparent upon reading and understanding the above description. Although embodiments of the present disclosure have been described with reference to specific example embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. An intraoral scanning system, comprising:
an intraoral scanner comprising:
one or more light projectors configured to project first light having a known first intensity onto a dental object; and
one or more cameras configured to capture one or more first images of the dental object illuminated by the first light; and
a one or more processors configured to:
determine a captured first intensity of the one or more first images;
estimate an amount of external illumination based at least in part on the known first intensity and the captured first intensity; and
perform an action based on the estimated amount of external illumination.

2. The intraoral scanning system of claim 1, wherein the first light is structured coherent light, wherein the first light has the known first intensity at one or more first wavelengths, wherein the captured first intensity is at one or more second wavelengths, and wherein the one or more second wavelengths include a wavelength not included in the one or more first wavelengths.

3. The intraoral scanning system of claim 2, wherein the one or more processors are further configured to:
determine that the captured first intensity for the wavelength not included in the one or more first wavelengths exceeds a threshold; and
output a warning about excessive external illumination.

4. The intraoral scanning system of claim 1, wherein performing the action comprises outputting a notice associated with the estimated amount of external illumination, wherein the notice comprises at least one of:
a visual notice output to a display of at least one of a computing device or an intraoral scanner; or
an audio notice output to a speaker of at least one of a computing device or an intraoral scanner.

5. The intraoral scanning system of claim 1, wherein the one or more first images comprise a plurality of frames, and wherein the one or more processors are further configured to:
determine, for each frame of the plurality of frames, whether the amount of external illumination for the frame exceeds a first threshold; and
determine whether a number of frames for which the amount of external illumination exceeds the first threshold exceeds a second threshold.

6. The intraoral scanning system of claim 1, wherein the one or more cameras comprise a plurality of cameras, wherein the one or more first images comprise a plurality of images each captured by a different camera of the plurality of cameras, and wherein the one or more processors are further configured to:
determine, for each image of the plurality of images, whether the amount of external illumination for the image exceeds a first threshold; and
determine whether a number of images for which the amount of external illumination exceeds the first threshold exceeds a second threshold.

7. The intraoral scanning system of claim 1, wherein:
the one or more light projectors are further configured to project second light having a known second intensity onto the dental object, wherein there is a known first difference between the second intensity and the first intensity;
the one or more cameras are further configured to capture one or more second images of the dental object illuminated by the second light; and
the one or more processors are further configured to:
determine a captured second intensity of the one or more second images; and
determine a second difference between the captured second intensity and the captured first intensity;
wherein the amount of external illumination is estimated based on a ratio of the first difference to the second difference.

8. The intraoral scanning system of claim 7, wherein the one or more processors are further configured to:
output the one or more first images to a display;
determine first average values of one or more color channels for the one or more first images;
determine second average values of the one or more color channels for the one or more second images;
adjust gains of the one or more color channels for the one or more second images based on a difference between the second average values and the first average values of the one or more color channels; and
output the one or more second images to the display using the adjusted gains for the one or more color channels.

9. The intraoral scanning system of claim 1, wherein:
the one or more light projectors are further configured to project second light having a known second intensity onto the dental object, wherein there is a known first difference between the second intensity and the first intensity;
the one or more cameras are further configured to capture one or more second images of the dental object illuminated by the second light; and
the one or more processors are further configured to:
determine a captured second intensity of the one or more second images;
again project the first light having the known first intensity onto the dental object;
capture one or more third images of the dental object illuminated by the first light;
determine a captured third intensity of the one or more third images;
determine an average of the captured first intensity and the captured third intensity; and
determine a second difference between the captured second intensity and the average of the captured first intensity and the captured third intensity;
wherein the amount of external illumination is estimated based on a ratio of the first difference to the second difference.

10. The intraoral scanning system of claim 1, wherein:
the one or more light projectors are further configured to alternately project the first light having the known first intensity and second light having a known second intensity onto the dental object, wherein there is a known first difference between the second intensity and the first intensity;
the one or more cameras are further configured to alternately capture the one or more first images of the dental object illuminated by the first light and one or more second images of the dental object illuminated by the second light; and
the one or more processors are further configured to:
determine captured intensities for each of the one or more first images and the one or more second images;
determine a first average of the captured intensities of the one or more first images in a moving window;
determine a second average of the captured intensities of the one or more second images in the moving window; and
determine a second difference between the second average and the first average;
wherein the amount of external illumination is estimated based on a ratio of the first difference to the second difference.

11. The intraoral scanning system of claim 1, wherein the one or more processors are further configured to:
determine that the amount of external illumination exceeds a threshold;
wherein performing the action comprises at least one of:
increasing an intensity of the first light;
reducing a gain of one or more cameras that capture the one or more first images; or
increasing a frame rate of the one or more cameras from a first frame rate to a second frame rate.

12. The intraoral scanning system of claim 11, wherein the one or more processors are further configured to:
introduce one or more dummy frames responsive to increasing the frame rate, wherein the one or more dummy frames are not used to generate images, and wherein a number of frames in the first frame rate and the second frame rate that are used to generate images is the same.

13. The intraoral scanning system of claim 1, wherein the first light has the known first intensity at one or more first wavelengths, wherein the captured first intensity is at one or more second wavelengths, and wherein:
the one or more cameras are further configured to capture one or more second images of the dental object while one or more light projectors that projected the first light are off; and
the one or more processors are further configured to:
determine a captured second intensity of the one or more second images at the one or more second wavelengths; and
determine a difference between the captured second intensity and the captured first intensity, wherein the difference indicates the amount of external illumination.

14. An intraoral scanning system, comprising:
an intraoral scanner comprising:
one or more structured light projectors configured to project structured light comprising a light pattern;
one or more non-structured light projectors configured to project non-structured light; and
one or more cameras configured to capture intraoral scan data comprising one or more images of a dental object illuminated by at least one of the one or more structured light projectors or the one or more non-structured light projectors; and
a computing device configured to:
estimate an amount of external illumination based at least in part on a) a known first intensity at which at least one of the one or more structured light projectors projected the structured light or the one or more non-structured light projectors projected the non-structured light and b) a captured intensity in the one or images of the dental object for one or more color channels; and
perform an action based on the estimated amount of external illumination.

15. The intraoral scanning system of claim 14, further comprising:
a polarization filter on the one or more cameras that matches a polarization of at least one of the structured light or the non-structured light.

16. The intraoral scanning system of claim 14, wherein the one or more cameras comprise global shutters.

17. The intraoral scanning system of claim 14, wherein the one or more cameras comprise one or more narrow band color filters matched to wavelengths output by at least one of the one or more structured light projectors or the one or more non-structured light projectors.

18. The intraoral scanning system of claim 14, further comprising:
a light blocking device attached to a probe of the intraoral scanner, wherein the light blocking device blocks at least a portion of the external illumination from entering an oral cavity during intraoral scanning, wherein the light blocking device is removable from the intraoral scanner.

19. The intraoral scanning system of claim 14, further comprising:
a dark filter on the one or more cameras.

20. The intraoral scanning system of claim 14, wherein performing the action comprises at least one of:
outputting warning of excessive external illumination; or
compensating for the external illumination.
